(19) United States
(12) Patent Application Publication
(10) Pub. No.: US 2026/0270831 A1
(43) Pub. Date: Sep. 10, 2026

(54) INTER-RAT CONDITIONAL HANDOVER

(71) Applicant: Boost SubscriberCo L.L.C., Englewood, CO (US)

(72) Inventors: Shubangi Kondapally, Littleton, CO (US); Rohit Singh, Denver, CO (US)

(21) Appl. No.: 19/071,340

(22) Filed: Mar. 5, 2025

(51) Int. Cl. H04W 36/36; H04B 17/318; H04W 36/00

(52) U.S. Cl. CPC H04W 36/362; H04B 17/328; H04W 36/0058

(57) ABSTRACT

A disclosed method may include (i) receiving, by a user equipment (UE) operating on a first radio access technology (RAT), a radio resource control (RRC) reconfiguration message from a network that includes conditional handover (CHO) information that is specific to a second RAT different from the first RAT and (ii) selecting, by the UE, a target cell supporting the second RAT when signal measurements of the target cell satisfy criteria specified in the CHO information.

### BRIEF SUMMARY

This disclosure is generally directed to systems, methods, and computer-readable media relating to inter-RAT conditional handover. In the realm of wireless communications, the landscape of radio access technologies (RATs) continues to evolve, presenting both opportunities and challenges for seamless connectivity. As users move through diverse environments, their devices may encounter multiple RATs, each offering distinct advantages in terms of coverage, capacity, and/or performance. The coexistence of various RATs, such as 5G, 4G, and/or Wi-Fi networks, may create a complex ecosystem where transitioning between these technologies may become increasingly common. In this context, the ability to perform smooth and/or efficient handovers between different RATs may become a helpful factor in maintaining consistent user experience and/or maximizing network utilization. Some handover mechanisms may primarily focus on transitions within a single RAT, potentially limiting the ability to leverage the full spectrum of available network resources across multiple technologies. As a result, users may experience interruptions in service, degraded performance, and/or inefficient use of network capacity when moving between areas covered by different RATs. Additionally, the varying characteristics of each RAT may introduce complexities in managing transitions, as parameters such as signal strength, quality of service, and/or network congestion may differ significantly between technologies. These challenges may be further compounded in dynamic urban environments, where the availability and/or performance of different RATs may fluctuate rapidly due to factors such as building density, user mobility, and/or network load variations.

One challenge in inter-RAT environments may arise from the varied characteristics and/or capabilities of each technology. For instance, 5G networks may offer high data rates and/or low latency in certain areas, while 4G networks may provide broader coverage in others. Wi-Fi networks, on the other hand, may offer cost-effective connectivity in localized hotspots. The decision-making process for handovers in such diverse scenarios may become more complex, as it may involve evaluating and/or comparing disparate network parameters across different RATs. Some handover mechanisms that rely solely on signal strength measurements within a single RAT may not be sufficient to make improved decisions in an inter-RAT context. This limitation may lead to suboptimal handovers, where a device may remain connected to a less suitable RAT even when better alternatives are available, potentially resulting in reduced performance and/or user satisfaction. Furthermore, the dynamic nature of wireless networks may introduce additional complexities, as the optimal RAT for a given user may change rapidly based on factors such as movement speed, application requirements, and/or network congestion. In scenarios where multiple RATs are available, devices may benefit from a more comprehensive evaluation technique that considers a broader range of parameters to make informed handover decisions. This may include factors such as predicted quality of service, network load, power consumption, and/or application-specific requirements, in addition to basic signal strength measurements.

An inter-RAT conditional handover (CHO) technique may address these challenges by enabling devices to autonomously evaluate and/or execute handovers across different RATs based on a comprehensive set of criteria. In an inter-RAT CHO system, a user equipment (UE) may receive conditional handover information for multiple RATs from the network. This information may include parameters such as signal strength thresholds, quality of service (QoS) requirements, and/or other relevant metrics for each potential target RAT. The UE may then monitor the available RATs, measuring their performance and/or comparing it against the provided criteria. When the conditions for a handover are met, the UE may autonomously initiate the transition to the most suitable RAT without waiting for explicit network commands. This proactive and/or device-centric technique may lead to faster, more efficient handovers that may better adapt to the dynamic nature of multi-RAT environments. By empowering the UE to make informed decisions based on a rich set of parameters, the inter-RAT CHO technique may improve the overall efficiency of network resource utilization and/or enhance the user experience across diverse wireless ecosystems.

The inter-RAT CHO technique may offer several potential benefits over other handover methods. By enabling the UE to make handover decisions based on a broader set of criteria across different RATs, it may enable more intelligent and/or context-aware network selection. For example, a device may choose to switch from a congested 5G cell to a less crowded 4G cell and/or a nearby Wi-Fi network, even if the 5G signal is stronger, to maintain better overall performance. This flexibility may lead to improved load balancing across different RATs and/or more efficient utilization of network resources. Additionally, the autonomous nature of the CHO process may reduce signaling overhead between the UE and/or the network, potentially lowering latency and/or improving the responsiveness of handovers. The technique may also enhance the user experience by minimizing interruptions during transitions between RATs, as the UE may prepare for the handover in advance based on the conditional criteria. Furthermore, the inter-RAT CHO technique may adapt to varying network conditions and/or user requirements more dynamically, potentially improving the overall reliability and/or performance of wireless connections in heterogeneous network environments. This adaptability may be helpful in scenarios such as high-mobility use cases, where rapid transitions between different RATs may be helpful to maintain improved or satisfying connectivity.

To further enhance the effectiveness of inter-RAT CHO, the technique may incorporate quality of service (QoS) evaluations into the handover decision-making process. Instead of relying solely on signal strength measurements, the UE may consider factors such as latency, throughput, and/or reliability when selecting a target RAT. This QoS-aware technique may involve measuring and/or predicting the potential QoS impact of a handover before executing it. For instance, if a device is currently engaged in a low-latency application on a 5G network, it may only initiate a handover to a 4G and/or Wi-Fi network if the predicted QoS in the new RAT meets and/or exceeds the current performance. By incorporating QoS considerations, the inter-RAT CHO technique may help maintain consistent application performance across different RATs, potentially improving user satisfaction and/or enabling more demanding use cases in heterogeneous network environments. The QoS evaluation process may also take into account application-specific requirements, enabling the system to prioritize different performance metrics based on the current user activity. For example, a video streaming application may prioritize throughput, while a real-time gaming application may place greater emphasis on low latency. This context-aware QoS evaluation may further refine the handover decision-making process, ensuring that the selected RAT aligns with the specific needs of the active applications on the device.

In some examples, a method includes (i) receiving, by a user equipment (UE) operating on a first radio access technology (RAT), a radio resource control (RRC) reconfiguration message from a network that includes conditional handover (CHO) information that is specific to a second RAT different from the first RAT, (ii) selecting, by the UE, a target cell supporting the second RAT when signal measurements of the target cell satisfy criteria specified in the CHO information, and (iii) executing, by the UE, a conditional handover to the selected target cell such that the UE autonomously transitions from the first RAT to the second RAT.

In some examples, the first RAT comprises a 5G network and the second RAT comprises a 4G network or a Wi-Fi network.

In some examples, the CHO information specifies a conditional preparation phase that prepares multiple candidate cells for potential handover or a conditional execution phase that triggers the UE to execute the handover to the selected target cell.

In some examples, selecting the target cell comprises measuring a quality of service parameter for the target cell, comparing the measured quality of service parameter to a threshold value, and selecting the target cell based on the measured quality of service parameter exceeding the threshold value.

In some examples, the RRC reconfiguration message comprises an event type specifying a conditional event for inter-RAT handover.

In some examples, the method comprises reporting, by the UE to the network, measurements of multiple neighbor cells supporting the second RAT.

In some examples, the network sends RRC reconfiguration messages for multiple candidate cells based on the reported measurements.

In some examples, selecting the target cell comprises choosing a cell with a best received signal strength indicator (RSSI) or best reference signal received power (RSRP) among multiple candidate cells.

In some examples, the method further comprises reattempting the conditional handover to a second candidate cell based on the conditional handover to the selected target cell failing.

In some examples, the CHO information comprises at least one threshold value for triggering the conditional handover.

In some examples, the at least one threshold value comprises a first threshold for a B1 event that triggers based on a neighbor cell becoming better than the first threshold, or a second threshold and a third threshold for a B2 event that triggers based on a serving cell becoming worse than the second threshold and a neighbor cell becoming better than the third threshold, wherein the second threshold and the third threshold are the same or different.

In some examples, the method further comprises sorting multiple candidate cells based on signal strength measurements before selecting the target cell.

In some examples, executing the conditional handover comprises sending an RRC reconfiguration complete message to the target cell.

In some examples, the method further comprises the UE falling back to a basic handover procedure based on the conditional handover failing after a predetermined number of attempts.

In some examples, the conditional handover executed by the UE conforms to 3GPP Release 16 or a later specification.

In some examples, the method further comprises reattempting the conditional handover with a next best candidate cell based on one or more candidate cells in an initial list failing to meet handover criteria.

In some examples, a non-transitory computer-readable medium has instructions stored thereon that, when executed by at least one physical computing processor, cause a computing device to perform operations comprising (i) receiving, by a user equipment (UE) operating on a first radio access technology (RAT), a radio resource control (RRC) reconfiguration message from a network that includes conditional handover (CHO) information that is specific to a second RAT different from the first RAT, (ii) selecting, by the UE, a target cell supporting the second RAT when signal measurements of the target cell satisfy criteria specified in the CHO information, and (iii) executing, by the UE, a conditional handover to the selected target cell such that the UE autonomously transitions from the first RAT to the second RAT.

In some examples, a system comprises at least one physical computing processor of a computing device and a non-transitory computer-readable medium that has instructions stored thereon that, when executed by the at least one physical computing processor, cause the computing device to perform operations comprising (i) receiving, by a user equipment (UE) operating on a first radio access technology (RAT), a radio resource control (RRC) reconfiguration message from a network that includes conditional handover (CHO) information that is specific to a second RAT different from the first RAT, (ii) selecting, by the UE, a target cell supporting the second RAT when signal measurements of the target cell satisfy criteria specified in the CHO information, and (iii) executing, by the UE, a conditional handover to the selected target cell such that the UE autonomously transitions from the first RAT to the second RAT.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to inter-RAT conditional handover.

FIG. 2 shows an example overview of an inter-RAT conditional handover scenario, illustrating a user equipment device, base stations for different radio access technologies, and potential handover connections.

FIG. 3 illustrates an example flowchart of the inter-RAT conditional handover process, showing the steps from receiving handover information to executing the handover or falling back to a basic handover procedure.

FIG. 4 depicts an example structure of a radio resource control (RRC) reconfiguration message containing conditional handover information for multiple radio access technologies.

FIG. 5 shows an example diagram of the user equipment decision-making process for inter-RAT conditional handover.

FIG. 6 presents an example sequence diagram of the inter-RAT conditional handover execution, showing the interactions between the user equipment, source and target base stations, and core network.

FIG. 7 illustrates an example quality of service evaluation process during an inter-RAT conditional handover, depicting pre-handover, handover execution, and post-handover phases.

FIG. 8 shows an example candidate cell selection process for inter-RAT conditional handover, including measurement, criteria application, and ranking of eligible cells.

FIG. 9 depicts an example fallback mechanism for inter-RAT conditional handover when multiple handover attempts fail, showing the progression to a basic handover procedure.

FIG. 10 illustrates an example real-world scenario of inter-RAT conditional handover in a dynamic urban environment, showing a user equipment moving through different network coverages and evaluating handover opportunities.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

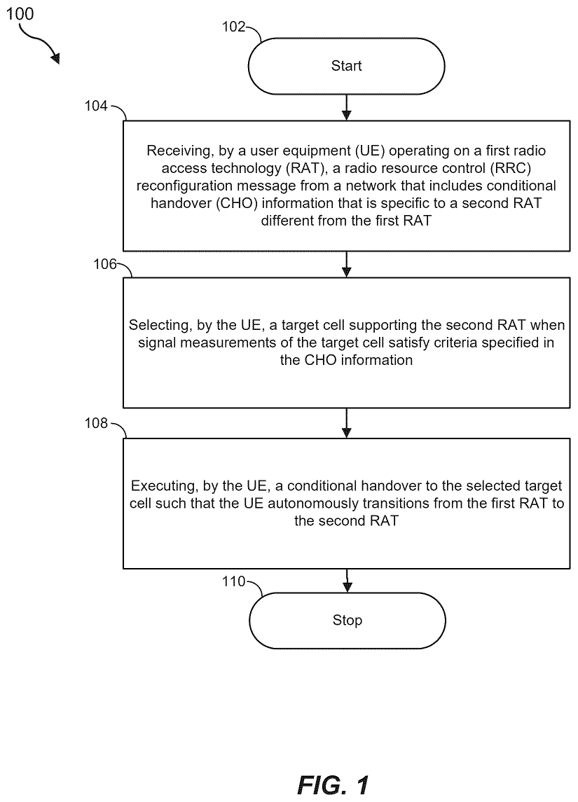

FIG. 1 shows a flow diagram for a method 100 relating to inter-RAT conditional handover. At step 102, method 100 may start. At step 104, method 100 includes receiving, by a user equipment (UE) operating on a first radio access technology (RAT), a radio resource control (RRC) reconfiguration message from a network that includes conditional handover (CHO) information that is specific to a second RAT different from the first RAT. At step 106, method 100 includes selecting, by the UE, a target cell supporting the second RAT when signal measurements of the target cell satisfy criteria specified in the CHO information. At step 108, method 100 includes executing, by the UE, a conditional handover to the selected target cell such that the UE autonomously transitions from the first RAT to the second RAT. At step 110, method 100 ends.

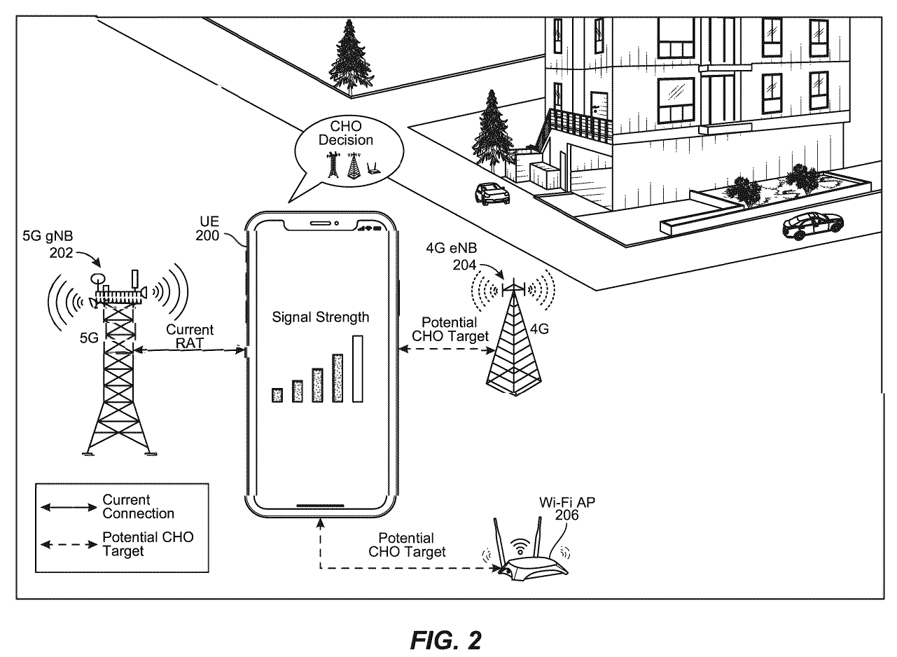

FIG. 2 shows an overview of an example inter-RAT conditional handover scenario. The figure illustrates a user equipment (UE) 200 in the center, represented by a smartphone icon. The UE 200 is shown with signal strength bars on its screen, indicating its current network connection status. To the left of the UE 200, a tall cellular tower labeled “5G gNB 202” represents the 5G base station. On the right side, a slightly shorter cellular tower labeled “4G eNB 204” depicts the 4G base station. In the bottom right corner, a router-like device labeled “Wi-Fi AP 206” represents the Wi-Fi access point. These diverse network elements may illustrate the multi-RAT environment in which the UE 200 may operate, providing various connectivity options that may be evaluated for potential handovers.

The connections between the UE 200 and the various network elements are depicted using different line styles. A solid line connects the UE 200 to the 5G gNB 202, representing the current active connection. This line is labeled “Current RAT” to indicate the UE's present radio access technology. Dashed lines extend from the UE 200 to both the 4G eNB 204 and the Wi-Fi AP 206, labeled as “Potential CHO Target” to signify possible conditional handover destinations. These visual representations may help illustrate the concept of a UE maintaining awareness of multiple RATs simultaneously and its ability to consider potential handover targets across different technologies. The bi-directional arrowheads on these lines may suggest the two-way communication that may occur during the handover process, including measurements, decisions, and execution steps.

Signal strength indicators are shown near each network element, with the 5G signal depicted as the strongest, followed by 4G, and then Wi-Fi. This visual representation may help illustrate the varying signal strengths that the UE 200 may encounter in a multi-RAT environment. These differing signal strengths may play a role in the UE's decision-making process when evaluating potential handover targets. The relative strengths shown in the figure may represent a typical scenario where the UE is currently connected to the strongest available network (5G in this case) but is also aware of and measuring other available networks that may become preferable as the UE moves or as network conditions change.

Above the UE 200, a thought bubble labeled “CHO Decision” contains small icons representing signal strength and quality of service. This element may visualize the UE's autonomous decision-making process for conditional handovers, taking into account various factors such as signal strength and QoS metrics. The inclusion of this thought bubble may emphasize the UE-centric nature of the conditional handover process, where the device itself may make decisions based on network-provided parameters and its own measurements. This autonomous decision-making capability may allow for more efficient and responsive handovers compared to purely network-controlled processes.

The figure also includes simplified buildings or trees in the background to provide context for the urban or suburban environment in which these network interactions may occur. This environmental context may help illustrate the real-world scenarios in which inter-RAT conditional handovers may be helpful, such as moving through areas with varying coverage from different network technologies. A legend in the bottom left corner explains the meaning of the different line styles used in the diagram, clarifying the distinction between current connections and potential CHO targets.

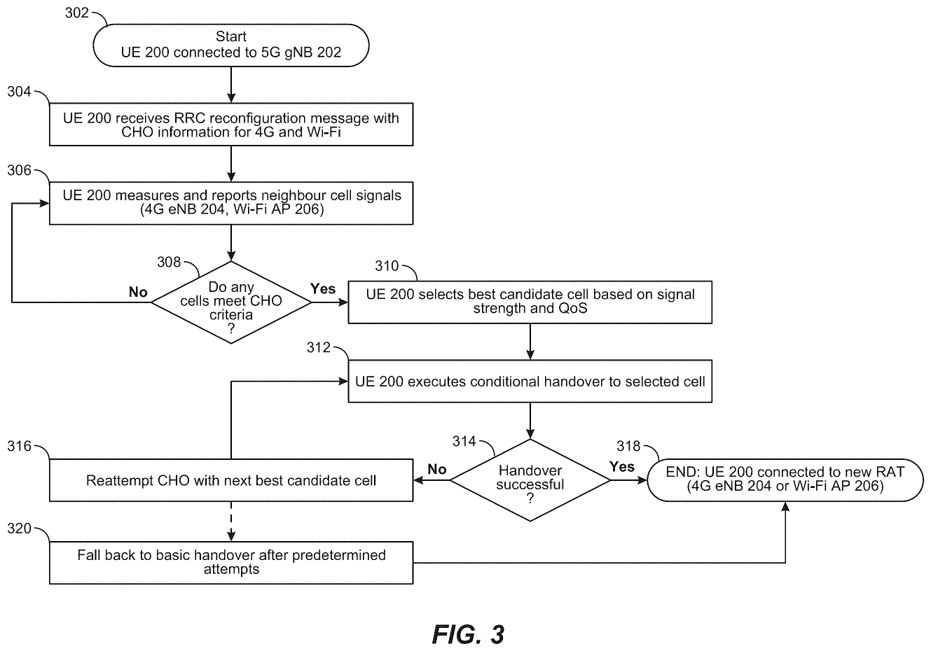

FIG. 3 shows an example flowchart diagram illustrating the inter-RAT conditional handover process flow. At step 302, the diagram begins with a rounded rectangle labeled START, indicating that the user equipment (UE) 200 is initially connected to the 5G gNB 202. This starting point may represent the typical scenario where a UE may be operating on a high-performance network but may benefit from the ability to transition to other radio access technologies (RATs) as conditions change. The flowchart then progresses through various stages of the conditional handover (CHO) process, showcasing the decision-making steps and potential outcomes that may occur during an inter-RAT handover scenario. This initial setup may provide context for the subsequent steps in the CHO process, setting the stage for the UE's autonomous decision-making and potential transitions between different network technologies. In some examples, the UE may be configured to continuously evaluate its network environment, even when connected to a high-performance network, to proactively identify potential handover opportunities that may improve overall connectivity and/or user experience. This continuous evaluation may help the UE adapt quickly to changing network conditions, such as moving from an area with strong 5G coverage to one where 4G or Wi-Fi may provide better performance.

At step 304, an arrow leads to a rectangle labeled UE 200 receives RRC reconfiguration message with CHO information for 4G and Wi-Fi. This step may illustrate the initial trigger for the CHO process, where the network may provide the UE with information about potential handover targets across different RATs. The inclusion of both 4G and Wi-Fi in this message may highlight the multi-RAT nature of the CHO technique, allowing for transitions between cellular and/or non-cellular networks. This RRC reconfiguration message may contain various parameters and/or thresholds that the UE may use to evaluate potential handover candidates. In some examples, this information may include signal strength thresholds, quality of service (QoS) requirements, and/or other relevant metrics specific to each RAT. The provision of this information may enable the UE to make informed decisions about potential handovers without constant communication with the network, potentially reducing signaling overhead and/or improving the efficiency of the handover process. The RRC reconfiguration message may also include time-to-trigger values, hysteresis parameters, and/or other criteria that may help prevent unnecessary handovers due to temporary fluctuations in network conditions. Additionally, the message may specify different sets of criteria for different scenarios, such as high-mobility versus stationary use cases, allowing for more context-aware handover decisions.

At step 306, the flowchart shows a rectangle labeled UE 200 measures and reports neighbor cell signals (4G eNB 204, Wi-Fi AP 206). This stage may represent the UE's active role in gathering information about its surrounding network environment. By measuring signals from neighboring cells across different RATs, the UE may build a comprehensive picture of available network options. The reporting aspect of this step may indicate that the UE may share this information with the network, potentially allowing for coordinated decision-making or network-assisted handovers in certain scenarios. This measurement and reporting process may be continuous, allowing the UE to maintain an up-to-date understanding of its network environment and respond quickly to changing conditions. In some examples, the UE may prioritize measurements based on factors such as signal strength, historical performance, and/or user preferences, potentially improving the use of device resources while still maintaining a comprehensive view of available networks.

At step 308, the flowchart shows a diamond-shaped decision point labeled “Do any cells meet CHO criteria?” This decision point may represent an aspect of the autonomous nature of the CHO process where the UE may evaluate the measured signals against the criteria provided in the RRC reconfiguration message. The diamond shape splits into two paths: a No path that loops back to step 306, and a Yes path that proceeds to the next stage of the handover process. The loop created by the No path may illustrate the continuous nature of the CHO evaluation process, where the UE may persistently monitor and re-evaluate network conditions until suitable handover candidates are identified. This persistent evaluation may help maintain improved network connectivity in dynamic environments where network conditions may change rapidly. In some examples, the UE may employ adaptive algorithms that adjust the frequency of evaluations based on factors such as the rate of change in network conditions, battery life considerations, and/or user activity patterns. The CHO criteria may also incorporate multi-dimensional thresholds that consider combinations of factors, such as signal strength, quality of service metrics, and/or network load, to make more informed decisions about when to initiate a handover. Additionally, the UE may maintain a history of past evaluations and handover attempts, using this information to refine its decision-making process over time and potentially improve the success rate of future handovers.

At steps 310 and 312, if the CHO criteria are met, the flowchart shows that the UE 200 may select the best candidate cell based on signal strength and/or QoS, and then execute the conditional handover to the selected cell. This selection process may involve comparing multiple eligible candidates across different RATs, potentially considering factors beyond simple signal strength. The inclusion of QoS in the selection criteria may indicate a more nuanced technique for handover decisions, where the UE may consider factors such as latency, throughput, and/or reliability in addition to raw signal strength. This multi-factorial decision process may help improve the overall user experience by selecting handover targets that may best meet the current application and/or user needs. In some examples, the UE may employ machine learning algorithms to predict the expected QoS of each candidate cell based on historical data and current network conditions. The UE may also take into account user preferences or application-specific requirements when making its selection. For instance, a video streaming application may prioritize throughput, while a voice call may prioritize low latency. The execution of the handover at step 312 may involve a series of signaling exchanges between the UE, the source cell, and the target cell to coordinate the transition. This process may include steps such as resource allocation in the target cell, synchronization with the new network, and the transfer of any ongoing data sessions.

At step 314, the flowchart progresses to another diamond-shaped decision point labeled “Handover successful?” This checkpoint may allow for verification of the handover process and may determine the next steps based on the outcome. If the handover is successful, the Yes path leads to step 318, the END state, where the UE 200 is connected to the new RAT (4G eNB 204 or Wi-Fi AP 206). This successful outcome may represent the completion of the inter-RAT transition, potentially resulting in improved connectivity or performance for the UE. In some examples, the UE may perform a post-handover evaluation to confirm that the new connection meets the expected performance criteria. This evaluation may include measuring the actual QoS parameters achieved on the new network and comparing them to the predicted values used in the selection process. The results of this evaluation may be used to refine future handover decisions and improve the accuracy of the selection algorithm. If the handover is not successful, the No path leads to step 316, a reattempt process, where the UE may try the CHO with the next best candidate cell. This reattempt mechanism may provide resilience to the handover process, allowing for multiple tries in case of initial failure. The UE may maintain a list of alternative candidate cells, ranked according to their suitability, and may proceed through this list in order until a successful handover is achieved or the list is exhausted.

At step 320, in scenarios where multiple reattempts may not result in a successful handover, the flowchart includes a fallback mechanism. This fallback option may involve reverting to a basic handover procedure after a predetermined number of CHO attempts. The inclusion of this fallback path may illustrate the robustness of the overall handover system, providing a safety net to maintain connectivity even in challenging scenarios where the conditional handover process may not succeed. This multi-layered technique for handover execution may help improve the reliability and performance of inter-RAT transitions in diverse network environments. In some examples, the fallback mechanism may involve more extensive network involvement, potentially leveraging additional network resources to facilitate the handover. The UE may also adjust its criteria or thresholds during the fallback process, potentially accepting a lower-quality connection to maintain basic connectivity rather than losing the connection entirely. Additionally, the UE may log information about the failed CHO attempts and the conditions under which the fallback was triggered. This data may be used for network optimization, troubleshooting, and improving future CHO algorithms. The fallback process may also include steps to gracefully degrade service quality if necessary, ensuring that critical functions remain operational even if high-bandwidth or low-latency requirements cannot be met immediately.

In some examples, the CHO information may specify a conditional preparation phase that prepares multiple candidate cells for potential handover or a conditional execution phase that triggers the UE to execute the handover to the selected target cell. The conditional preparation phase, as illustrated in FIG. 3, may begin when the UE 200 receives the RRC reconfiguration message containing CHO information for multiple RATs. This phase may involve the UE gathering and analyzing data about potential target cells across different technologies, such as 4G eNB 204 and Wi-Fi AP 206. The preparation may include tasks such as measuring signal strengths, estimating quality of service parameters, and/or pre-allocating resources for each candidate cell. The UE may maintain a dynamic list of prepared cells, continuously updating their status based on changing network conditions and/or the UE's movement patterns. In parallel, the network may also engage in preparation activities, such as reserving resources on potential target cells, updating routing tables, and/or establishing temporary identifiers for the UE. The conditional execution phase may be triggered when specific criteria are met, as depicted by the decision diamond in FIG. 3 asking “Do any cells meet CHO criteria?” This phase may involve the UE autonomously selecting the most suitable target cell from the prepared candidates and initiating the handover process. The execution may include steps such as synchronizing with the target cell, transferring context information, and/or redirecting data flows. The UE may execute a series of conditional checks before finalizing the handover, potentially reverting to the preparation phase if conditions change unexpectedly. The transition between these phases may be fluid, with the UE continuously evaluating and updating its prepared candidates while being ready to execute a handover at any moment. This phased technique may allow for more efficient use of network resources by preparing multiple options in advance while maintaining the flexibility to adapt to rapidly changing conditions in heterogeneous network environments. The separation of preparation and execution phases may enable more sophisticated decision-making algorithms that consider a broader range of factors and historical data when selecting the optimal target cell for handover.

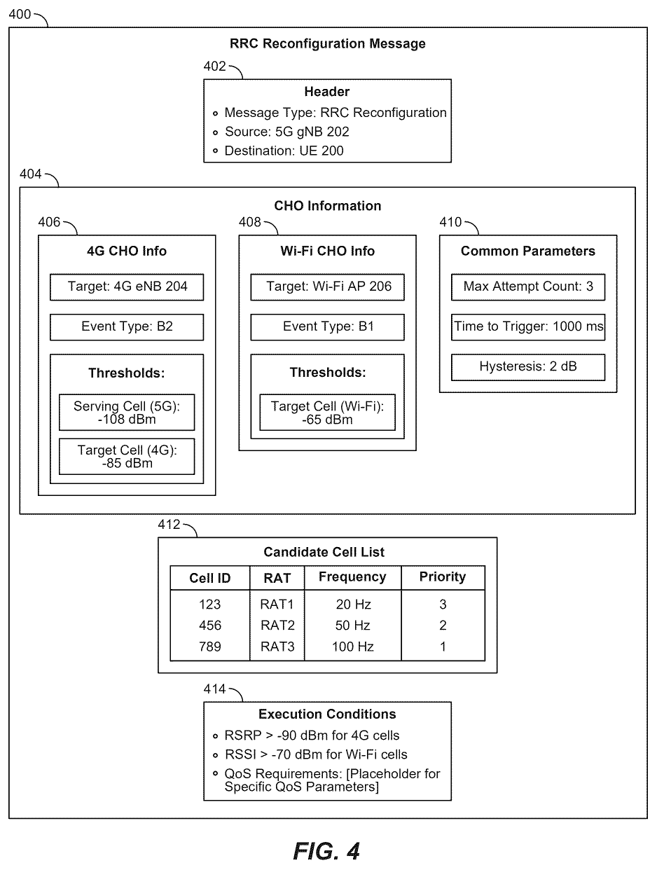

FIG. 4 shows an example detailed structure of the RRC reconfiguration message 400 for multi-RAT conditional handover. The figure illustrates a comprehensive layout of the message components, providing insight into the information exchanged between the network and the user equipment (UE) to facilitate inter-RAT handovers. The overall structure of the RRC Reconfiguration Message 400 may serve as a container for various subcomponents, each playing a specific role in the conditional handover process. This hierarchical arrangement of information within the message may allow for efficient parsing and processing by the receiving UE, potentially improving the speed and reliability of handover decisions. In some examples, the structure of the message may be extensible, allowing for the addition of new fields or parameters in future iterations of the protocol without breaking backwards compatibility. This flexibility may be helpful in accommodating evolving network technologies and handover scenarios.

Immediately below the main message box, the Header 402 section is shown. This header may include metadata about the message, such as the message type (RRC Reconfiguration), the source (5G gNB 202), and the destination (UE 200). The inclusion of this information may help facilitate proper routing and handling of the message within the network and by the UE. In some examples, additional fields may be included in the header, such as a timestamp, sequence number, and/or protocol version. These additional fields may assist in message ordering, duplicate detection, and/or compatibility checking. The header information may also be used by network elements to prioritize or queue messages based on their urgency or relevance to current network conditions. Furthermore, the header may contain security-related information, such as integrity protection and/or encryption indicators, to facilitate the authenticity and confidentiality of the message contents.

The CHO Information 404 section contains detailed parameters for conditional handover decisions. This section is divided into three subsections: 4G CHO Info 406, Wi-Fi CHO Info 408, and Common Parameters 410. The 4G CHO Info 406 subsection provides specific information for handovers to 4G networks, including the target 4G eNB 204, event type (B2), and thresholds for both the serving 5G cell (−108 dBm) and the target 4G cell (−85 dBm). These thresholds may be used by the UE to determine when conditions are favorable for a handover to the 4G network. The Wi-Fi CHO Info 408 subsection similarly provides information for handovers to Wi-Fi networks, specifying the target Wi-Fi AP 206, event type (B1), and a threshold for the target Wi-Fi cell (−65 dBm). The inclusion of both 4G and Wi-Fi information in the same message highlights the multi-RAT nature of the conditional handover technique, allowing the UE to consider diverse network options simultaneously.

The Common Parameters 410 subsection includes settings that may apply to all potential handovers, regardless of the target RAT. These parameters include the maximum attempt count (3), time to trigger (1000 ms), and/or hysteresis (2 dB). The max attempt count may limit the number of handover attempts to prevent excessive signaling or to trigger a fallback mechanism if multiple attempts fail. The time to trigger parameter may introduce a delay between when handover conditions are met and when the handover is executed, potentially reducing unnecessary handovers due to temporary fluctuations in signal strength. The hysteresis value may help prevent ping-pong effects by requiring a significant improvement in signal strength before initiating a handover. In some examples, these common parameters may be adjustable based on network conditions, UE mobility patterns, and/or specific service requirements, allowing for more dynamic and context-aware handover behaviors.

The Candidate Cell List 412 section provides a structured view of potential handover targets. Organized as a table with columns for Cell ID, RAT, Frequency, and/or Priority, this list may offer a comprehensive overview of available network options. The inclusion of multiple cells from different RATs in this list underscores the multi-RAT nature of the handover process, enabling the UE to consider a diverse range of options when making handover decisions. The priority field may be helpful in scenarios where network preferences or load balancing considerations come into play, potentially influencing the UE's selection process beyond simple signal strength comparisons. In some implementations, this list may be dynamically updated based on the UE's location, movement patterns, or network conditions, facilitating a scenario where the most relevant and up-to-date options are available for consideration.

The Execution Conditions 414 section at the bottom of the message specifies the criteria that must be met for a handover to be initiated. These conditions include RSRP thresholds for 4G cells (>−90 dBm) and RSSI thresholds for Wi-Fi cells (>−70 dBm), as well as a placeholder for QoS requirements. The inclusion of RAT-specific thresholds acknowledges the different characteristics and performance metrics of various network technologies. The QoS requirements placeholder may allow for the specification of more complex conditions based on factors such as latency, throughput, and/or reliability, potentially enabling more nuanced handover decisions that consider the specific needs of different applications or services. In some scenarios, these execution conditions may be dynamically adjusted based on network load, time of day, or user preferences, allowing for more adaptive and context-aware handover behaviors.

In some examples, various event types may be used to trigger conditional handover processes in wireless communication systems. These event types may be defined in industry standards, particularly those set forth by the 3rd Generation Partnership Project (3GPP) for cellular networks. The 3GPP specifications, such as TS 36.331 for LTE and TS 38.331 for 5G NR, may provide detailed definitions and parameters for a wide range of event types, including but not limited to A1 (serving cell becomes better than threshold), A2 (serving cell becomes worse than threshold), A3 (neighbor cell becomes offset better than serving cell), A4 (neighbor cell becomes better than threshold), A5 (serving cell becomes worse than threshold1 and neighbor cell becomes better than threshold2), A6 (neighbor cell becomes offset better than secondary cell), and for 5G NR, A7 (neighbor cell becomes offset better than serving cell for specific beams) and/or A8 (beam quality of neighbor cell becomes better than threshold). The A3 event, a standard event type in 3GPP specifications, may be primarily used for intra-RAT handovers and may trigger when a neighbor cell becomes offset better than the serving cell. This relative comparison between cells, as defined in the industry standards, may allow for more dynamic handover decisions based on the current network environment. Beyond these event types specified by 3GPP, the standards may also allow for the implementation of custom events tailored to specific operational requirements and/or unique network topologies. The IEEE 802.11 standards for Wi-Fi networks may also define similar concepts, although they may use different terminology. For example, the IEEE 802.11k amendment may introduce the Radio Resource Measurement capability, which may include mechanisms for triggering handovers based on signal strength and/or quality measurements.

In some examples, the at least one threshold value may comprise a first threshold for a B1 event that triggers based on a neighbor cell becoming better than the first threshold, or a second threshold and a third threshold for a B2 event that triggers based on a serving cell becoming worse than the second threshold and a neighbor cell becoming better than the third threshold, wherein the second threshold and the third threshold are the same or different. As illustrated in FIG. 4, the RRC Reconfiguration Message 400 contains a CHO Information section 404 that specifies these thresholds for different RATs. The B1 event, as defined in the 3GPP specifications, may be particularly useful for identifying potential target cells that have reached a minimum acceptable signal strength and/or quality level across different RATs. This is exemplified in the Wi-Fi CHO Info 408 subsection, where a B1 event type is specified with a threshold of −65 dBm for the target Wi-Fi cell. For instance, this B1 event may be configured to trigger when a Wi-Fi neighbor cell's RSSI exceeds −65 dBm, indicating that the Wi-Fi cell may provide sufficient coverage for a potential inter-RAT handover from a cellular network. The B2 event, also specified in the 3GPP standards, may be set to trigger when the serving cell becomes worse than one threshold and a neighbor cell of a different RAT becomes better than another threshold simultaneously. This dual-threshold approach is evident in the 4G CHO Info 406 subsection, which shows a B2 event type with thresholds for both the serving cell (−108 dBm) and the target cell (−85 dBm). This may help in identifying situations where an inter-RAT handover is not only desirable due to improving conditions in a neighbor cell, but also necessary due to degrading conditions in the current serving cell. As an example, this B2 event may be configured to trigger when a 5G serving cell's RSRP drops below −108 dBm (second threshold) and a 4G neighbor cell's RSRP exceeds −85 dBm (third threshold). In this case, the second and third thresholds are different, reflecting the distinct characteristics and/or requirements of the two RATs. However, in some implementations, these thresholds may be set to the same value if desired, which could be specified in the Common Parameters 410 section of the CHO Information. The B1 and B2 events may be particularly valuable for inter-RAT handovers, as they may allow for the comparison of cells across different technologies using standardized metrics and/or thresholds, as demonstrated by the diverse threshold values and event types specified in the CHO Information 404 of the RRC Reconfiguration Message 400.

In some examples, the RRC reconfiguration message may comprise an event type specifying a conditional event for inter-RAT handover. As illustrated in FIG. 4, the RRC Reconfiguration Message 400 may include a CHO Information section 404 that contains specific details about conditional handover events for different RATs. Within this section, the 4G CHO Info 406 and Wi-Fi CHO Info 408 subsections may each include an Event Type field. For instance, the 4G CHO Info 406 may specify an Event Type B2, while the Wi-Fi CHO Info 408 may indicate an Event Type B1. These event types may serve as triggers for initiating the conditional handover process, each tailored to the characteristics of its respective RAT. The B2 event, for example, may be configured to trigger when the serving cell becomes worse than one threshold and a neighbor cell becomes better than another threshold, as shown by the thresholds listed in the 4G CHO Info 406. Conversely, the B1 event may be set to trigger when a neighbor cell becomes better than a single absolute threshold, as depicted in the Wi-Fi CHO Info 408. The RRC reconfiguration message may also include additional event types beyond B1 and B2, such as A3 for intra-RAT handovers or custom event types designed for specific network scenarios. These event types may be further customized with parameters like time-to-trigger, hysteresis, and offset values, which may be included in the Common Parameters 410 section of the message. The UE may use these event specifications to configure its measurement and reporting procedures, adjusting the frequency and criteria of its evaluations based on the specified event types. In some implementations, the event types may be dynamically updated by the network based on factors such as network load, time of day, or known areas of poor coverage. The RRC reconfiguration message may also include compound event types that combine multiple conditions across different RATs, allowing for more nuanced handover decisions. For example, an event might trigger only if both signal strength and quality of service metrics meet certain thresholds across two or more RATs simultaneously. The flexibility of the event type specification in the RRC reconfiguration message may allow for adaptive handover behaviors that can be fine-tuned to specific network environments and user mobility patterns, potentially improving the overall efficiency and user experience of inter-RAT handovers.

In some examples, the CHO information may comprise at least one threshold value for triggering the conditional handover. As illustrated in FIG. 4, the RRC Reconfiguration Message 400 may include a CHO Information section 404 that contains specific threshold values for different RATs. For instance, the 4G CHO Info 406 subsection shows threshold values for both the serving cell (−108 dBm) and the target cell (−85 dBm). Similarly, the Wi-Fi CHO Info 408 subsection includes a threshold value for the target Wi-Fi cell (−65 dBm). These threshold values may serve as triggers for initiating the conditional handover process, each tailored to the characteristics of its respective RAT. The threshold values may be expressed in various units of measurement, such as dBm for signal strength, dB for signal-to-noise ratio, or Mbps for throughput. In some scenarios, multiple threshold values may be specified for a single RAT, potentially allowing for more nuanced handover decisions. For example, separate thresholds may be set for uplink and/or downlink performance, or for different quality of service metrics such as latency and/or packet loss rate. The CHO information may also include dynamic threshold values that adjust based on network conditions, time of day, and/or user mobility patterns. These adaptive thresholds may help improve the accuracy of handover decisions in changing network environments. Additionally, the threshold values may be associated with specific event types, as shown in the Event Type fields of the CHO Info subsections. The CHO information may further include hysteresis values and/or time-to-trigger parameters, as seen in the Common Parameters 410 section, which may work in conjunction with the threshold values to prevent unnecessary handovers due to temporary fluctuations in network conditions. In some implementations, the threshold values may be set relative to the current serving cell's performance rather than absolute values, allowing for more context-aware handover decisions. The CHO information may also specify different sets of threshold values for different user equipment capabilities, network slices, and/or service types, potentially enabling more tailored handover behaviors for specific use cases or quality of service requirements. Moreover, the threshold values may be combined in logical expressions to create complex triggering conditions, such as requiring multiple thresholds to be met simultaneously or in a specific sequence before initiating a handover. This flexible threshold-based technique may allow network operators to fine-tune handover behaviors to match specific network architectures, user mobility patterns, and/or quality of service requirements, potentially improving the overall efficiency and/or user experience of inter-RAT handovers.

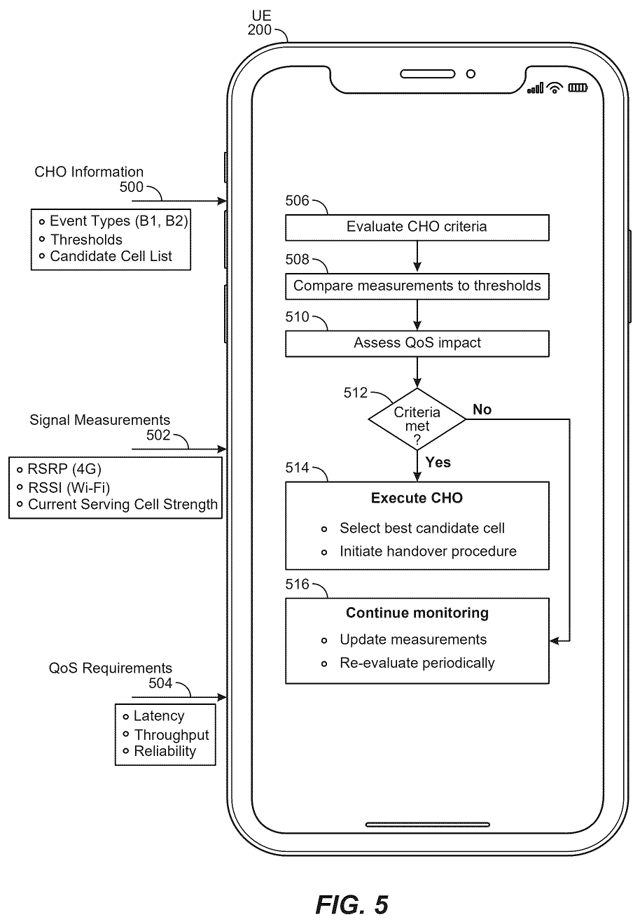

FIG. 5 shows a diagram illustrating an example UE decision-making process for inter-RAT conditional handover. The figure centers around a large smartphone icon representing the UE 200, emphasizing its role in the handover decision process. This visual representation may help convey the autonomous nature of the conditional handover technique, where the UE may play an active role in evaluating and/or executing handover decisions based on multiple inputs and/or criteria. The centrality of the UE 200 in this diagram may underscore the shift towards more distributed and/or intelligent network management techniques, potentially reducing the burden on centralized network controllers and/or improving the responsiveness of handover processes in dynamic environments. In some examples, this UE-centric approach may allow for more personalized and/or context-aware handover decisions, taking into account factors such as user preferences, application requirements, and/or device capabilities that may not be readily available to the network infrastructure.

Three input arrows point into the UE 200 from the left side, representing the example information sources that the UE may consider in its decision-making process. These inputs are labeled CHO Information 500, Signal Measurements 502, and QoS Requirements 504. The CHO Information 500 input may represent the data received from the network in the RRC reconfiguration message, as detailed in FIG. 4. This information may include event types (B1, B2), thresholds, and/or a candidate cell list. The inclusion of this network-provided information may enable the UE to align its decision-making process with network preferences and/or policies, potentially improving overall system performance and/or resource utilization. In some scenarios, this CHO information may be dynamically updated by the network based on changing conditions and/or load balancing requirements, providing the UE with the most current criteria for handover decisions. The UE may also maintain a history of previous CHO information updates, potentially allowing it to identify trends and/or anticipate future network conditions based on past patterns.

The Signal Measurements 502 input may represent the UE's own observations of its radio environment. This may include measurements such as RSRP for 4G cells, RSSI for Wi-Fi access points, and/or the current serving cell strength. These measurements may provide real-time data about the quality and/or availability of various network options, enabling the UE to make informed decisions based on its immediate surroundings. The UE may employ various techniques to gather and/or process these measurements, potentially including advanced signal processing algorithms, machine learning models for prediction, and/or historical data analysis to identify trends and/or patterns in network performance. In some implementations, the UE may prioritize and/or weight certain measurements based on factors such as reliability, recency, and/or relevance to current application requirements. The UE may also consider additional environmental factors, such as device mobility patterns and/or geographical location, to provide context for the signal measurements and/or improve the accuracy of handover decisions.

The QoS Requirements 504 input may represent the performance needs of the UE's current applications and/or user preferences. This may include factors such as latency, throughput, and/or reliability. By considering these requirements in the handover decision process, the UE may attempt to select a target network that not only offers strong signal strength but also meets the specific preferences or requests of the active services and/or applications. This QoS-aware approach may help improve user experience by maintaining consistent performance across different RATs and/or network conditions. In some examples, the QoS requirements may be dynamically adjusted based on the current application mix, user activity patterns, and/or device status (e.g., battery level, processing load). The UE may also maintain a historical record of QoS performance across different networks and/or RATs, potentially using this information to make more informed predictions about the expected QoS impact of potential handovers.

Inside the UE 200 icon, a flowchart-style process illustrates the internal decision-making steps. The process begins with step 506, which may involve analyzing the received CHO Information 500 in conjunction with the current network state. This evaluation step may include parsing the event types, thresholds, and/or candidate cell list to establish the framework for subsequent decision-making. In some examples, the UE may apply weighting factors to different criteria based on past performance or learned preferences, potentially improving the relevance of the evaluation process over time. The UE may also consider additional contextual information, such as its current mobility state, historical handover patterns, and/or time-of-day usage trends, to refine its interpretation of the CHO criteria. Furthermore, the evaluation process may incorporate adaptive thresholds that adjust based on the UE's recent experience, potentially enabling more nuanced decision-making in dynamic network environments. The UE may also maintain a database of previous CHO evaluations and their outcomes, using this historical data to inform and improve its current evaluation techniques through machine learning algorithms.

At step 508, the UE may perform a detailed analysis of the Signal Measurements 502 in relation to the thresholds specified in the CHO Information 500. This comparison may be performed for multiple candidate cells across different RATs simultaneously, allowing for a comprehensive assessment of the available network options. The UE may employ sophisticated algorithms to normalize and/or compare measurements across different technologies, potentially accounting for factors such as measurement uncertainty and/or temporal variations in signal strength. In some implementations, the UE may use advanced statistical techniques to filter out noise and identify significant trends in the signal measurements, potentially improving the reliability of its comparisons. The comparison process may also consider the rate of change of signal measurements, anticipating potential future conditions and factoring this predictive element into the decision-making process. Additionally, the UE may employ context-aware comparison techniques that take into account factors such as the user's location, movement speed, and/or typical usage patterns to interpret the significance of measured signal strengths in relation to the specified thresholds.

At step 510, the UE may assess the QoS impact of potential handover options. This step may involve predicting how a transition to each candidate cell might affect the QoS experienced by active applications and/or services. The assessment may take into account the QoS Requirements 504, historical performance data, and/or current network conditions to estimate the potential benefits and/or drawbacks of each handover option. In some implementations, the UE may use machine learning models trained on past handover outcomes to improve the accuracy of these QoS impact predictions. The QoS assessment may consider multiple parameters simultaneously, such as latency, throughput, jitter, and/or packet loss, potentially weighting these factors based on the requests or specifications of currently active applications. The UE may also simulate the handover process for each candidate cell, estimating the temporary service disruption during the transition and factoring this into the overall QoS impact assessment. Furthermore, the assessment may consider the long-term stability of the candidate cells, evaluating factors such as historical congestion patterns and/or frequency of previous handover failures to predict the sustained QoS that might be achieved post-handover.

The decision process culminates in step 512, represented by a diamond shape. This decision point may determine whether the conditions for executing a conditional handover have been satisfied based on the preceding evaluation steps. The criteria for a positive decision may involve a complex interplay of factors, potentially including signal strength improvements, QoS predictions, and/or network preferences specified in the CHO information. In some examples, the decision criteria may be implemented as a multi-dimensional threshold, requiring improvements across multiple parameters simultaneously before triggering a handover. The UE may also employ hysteresis techniques to prevent rapid oscillations between cells, potentially requiring a sustained period of improved conditions before confirming that the criteria are met. Additionally, the decision process may incorporate probabilistic elements, assessing the likelihood of successful handover completion and/or sustained performance improvements when determining whether the criteria have been satisfied. The UE may also consider energy efficiency in its decision-making, potentially adjusting its criteria based on its current battery level or power consumption state to balance performance improvements against energy conservation goals.

From step 512, two possible paths emerge. If the criteria are met, the Yes path leads to step 514. This step may involve selecting the best candidate cell from among those that meet the criteria and/or initiating the handover procedure. The selection of the best candidate may involve additional optimization, potentially considering factors such as expected handover success probability and/or long-term stability of the target network. In some implementations, the UE may prepare for the handover by pre-allocating resources, buffering data, or initiating preliminary signaling to minimize the interruption of service during the transition. The execution step may also involve coordinating with the current serving cell to ensure a smooth handover process, potentially including the transfer of context information or the preparation of backup plans in case of handover failure. Furthermore, the UE may log detailed information about the decision-making process and the conditions that led to the handover execution, potentially using this data to refine its decision-making algorithms for future handover scenarios.

If the criteria are not met, the No path leads to step 516. This step may involve updating measurements and/or re-evaluating the handover conditions periodically. The UE may adjust the frequency of these re-evaluations based on factors such as its mobility state, the rate of change in network conditions, and/or the urgency of potential handover needs. In some examples, step 516 may also involve predictive analysis to anticipate future network conditions and/or prepare for potential handovers proactively. The UE may employ adaptive measurement techniques during this monitoring phase, potentially adjusting its measurement intervals or focusing on specific parameters based on recent trends or predicted changes in network conditions. Additionally, the monitoring process may include background tasks to refine the UE's understanding of its environment, such as building and updating coverage maps, learning typical signal strength patterns in frequently visited areas, or identifying correlations between certain network conditions and successful handover opportunities. This continuous learning process may help improve the efficiency and accuracy of future handover decisions.

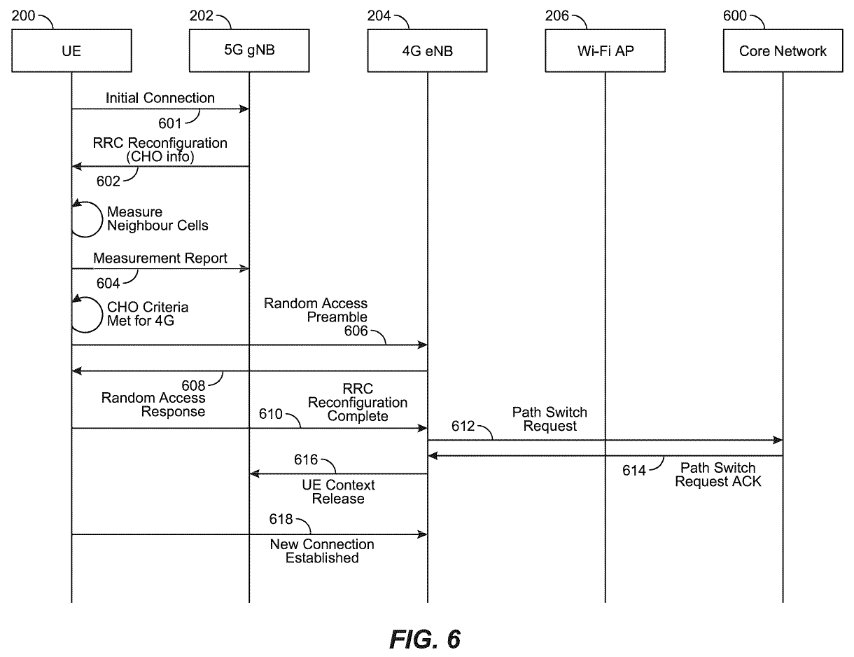

FIG. 6 shows an example sequence diagram illustrating the execution of a multi-RAT conditional handover. The diagram depicts interactions between five participants: UE 200, 5G gNB 202, 4G eNB 204, Wi-Fi AP 206, and Core Network 600. These participants are represented by vertical lifelines, with interactions between them shown as horizontal arrows. The sequence of events flows from top to bottom, providing a chronological view of the handover process.

The diagram begins with step 601, showing the initial connection between UE 200 and 5G gNB 202. This connection may represent the starting point for the conditional handover process, where the UE is initially served by a 5G network. The establishment of this initial connection may involve various signaling procedures and authentication steps not explicitly shown in the diagram. In some scenarios, the UE may have been connected to this 5G network for an extended period before the conditions for a conditional handover arise. The initial connection may also involve the exchange of capability information between the UE and the network, potentially including the UE's support for conditional handover procedures and/or its ability to operate on multiple RATs. This capability exchange may help the network tailor its subsequent handover-related communications to the specific features supported by the UE.

Following the initial connection, step 602 shows the 5G gNB 202 sending an RRC Reconfiguration message containing CHO information to UE 200. This message may include details such as measurement thresholds, candidate cell lists, and/or other parameters necessary for the UE to evaluate potential handover targets. The CHO information may be tailored to the specific network conditions and/or may include instructions for evaluating multiple RATs, including 4G and/or Wi-Fi options. In some implementations, this message may also include time-to-trigger values, hysteresis parameters, and/or other criteria to help prevent unnecessary handovers due to temporary fluctuations in network conditions. The RRC Reconfiguration message may be structured to allow for efficient parsing by the UE, potentially using a hierarchical format that groups related parameters and/or allows for easy extensibility to accommodate future enhancements to the CHO process. The message may also include security-related information to help facilitate secure handovers between different RATs and/or network domains.

After receiving the CHO information, UE 200 may begin measuring neighbor cells. This internal process may involve scanning for signals from nearby 4G eNBs, Wi-Fi APs, and/or other 5G gNBs. The UE may employ various techniques to efficiently measure multiple RATs simultaneously, potentially using advanced signal processing algorithms to extract relevant information from complex radio environments. In some examples, the UE may prioritize measurements based on factors such as signal strength, historical performance data, and/or user preferences. The measurement process may be adaptive, with the UE adjusting its scanning frequency and/or focus based on its mobility state, battery level, and/or the stability of current network conditions. Following these measurements, step 604 shows the UE sending a Measurement Report to the 5G gNB 202. This report may contain detailed information about the signal strengths, quality indicators, and/or other relevant parameters for the measured neighbor cells across multiple RATs. The format and content of this report may be standardized to enable consistent interpretation by different network elements, while also providing flexibility to include RAT-specific measurements as needed.

Following the measurement report, the UE 200 may internally evaluate the CHO criteria for the measured cells. This process may involve comparing the measured signal strengths and/or quality indicators against the thresholds provided in the CHO information received earlier. The UE may apply complex algorithms to weigh multiple factors, potentially including predicted quality of service, energy efficiency, and/or user preferences, when determining if a handover is warranted. In this example, the diagram shows that the CHO criteria are met for a 4G cell, indicating that the UE has determined that a handover to the 4G network may be beneficial. At step 606, the UE 200 initiates the resource preparation phase by sending a Random Access Preamble to the target 4G eNB 204. This step may mark the beginning of the actual handover execution process. The preamble may be selected from a set of preambles specifically allocated for CHO purposes, potentially allowing the target network to prioritize or expedite the handover process. In response, step 608 shows the 4G eNB 204 sending a Random Access Response back to the UE 200. This response may include timing advance information, temporary cell-specific identifiers, and/or initial uplink resource grants to help facilitate the UE's access to the target network. The exchange of these messages may help establish initial synchronization between the UE and the target network, laying the groundwork for a smooth transition.

Step 610 depicts the UE 200 sending an RRC Reconfiguration Complete message to the 4G eNB 204. This message may signify that the UE has successfully applied the new radio resource configuration and is ready to commence communication over the new RAT. The contents of this message may include confirmation of the applied configuration, any requested modifications, and/or additional information to help facilitate the handover process. Upon receiving this message, the target network may finalize the radio resource allocation for the UE and prepare to handle its traffic. The handover process then moves to the core network level with steps 612 and 614. In step 612, the 4G eNB 204 sends a Path Switch Request to the Core Network 600. This request may initiate the process of redirecting the UE's data path from the 5G network to the 4G network. The core network may perform various checks and updates to its internal tables and databases to reflect this change. Step 614 shows the Core Network 600 acknowledging the path switch with a Path Switch Request ACK sent back to the 4G eNB 204. This acknowledgment may confirm that the core network has successfully updated its routing information and is ready to forward traffic to the UE via the new 4G path.

Step 616 illustrates the 4G eNB 204 sending a UE Context Release message to the 5G gNB 202. This step may help facilitate the cleanup of resources in the source network that were allocated to the UE. The context release may include information about the successful handover, potentially allowing the source network to update its records and free up any reserved resources. Finally, step 618 shows the establishment of a new connection between the UE 200 and the 4G eNB 204, completing the handover process. This new connection may represent the UE's full integration into the 4G network, with all necessary configurations applied and data paths established. Throughout this process, the Wi-Fi AP 206 remains inactive, as the handover in this example occurs between 5G and 4G networks. However, its presence in the diagram may highlight the multi-RAT nature of the CHO technique, indicating that Wi-Fi could have been a potential handover target under different circumstances. The entire sequence of events from step 600 to step 618 may occur within a very short timeframe, potentially minimizing any service disruption experienced by the user during the RAT transition.

In some examples, the network may send RRC reconfiguration messages for multiple candidate cells based on the reported measurements. As illustrated in FIG. 6, the inter-RAT conditional handover process may involve multiple network elements and message exchanges. The UE 200 may initially be connected to the 5G gNB 202, as shown by the initial connection at the top of the diagram. Following this connection, the 5G gNB 202 may send an RRC Reconfiguration message containing CHO information 602 to the UE 200. This message may include details about potential candidate cells across different RATs. Based on this information, the UE 200 may perform measurements of neighbor cells, which may then be reported back to the 5G gNB 202 via a Measurement Report 604. Upon receiving these measurements, the network, represented by the 5G gNB 202, may evaluate the reported data and determine that multiple candidate cells are suitable for potential handover. In response, the network may generate and send multiple RRC reconfiguration messages, each tailored to a specific candidate cell. These messages may not be explicitly shown in FIG. 6 but may be considered part of the ongoing communication between the UE 200 and the 5G gNB 202. The content of these RRC reconfiguration messages may vary depending on the characteristics of each candidate cell and/or its associated RAT. For instance, a message for a 4G eNB 204 candidate may include parameters specific to LTE handover procedures, while a message for a Wi-Fi AP 206 candidate may contain information relevant to Wi-Fi association processes. Each message may include updated threshold values, event types, and/or other CHO criteria tailored to the specific candidate cell. The network may also prioritize these messages based on factors such as signal strength, predicted quality of service, and/or network load balancing considerations. In some implementations, the network may send these multiple RRC reconfiguration messages sequentially, allowing the UE 200 to process and prepare for each potential handover target individually. Alternatively, the network may bundle information for multiple candidate cells into a single, comprehensive RRC reconfiguration message, potentially reducing signaling overhead. The UE 200 may then use this information to prepare for potential handovers to multiple targets simultaneously, as indicated by the CHO criteria met for 4G step in FIG. 6. This technique of providing RRC reconfiguration messages for multiple candidate cells may enhance the flexibility and efficiency of the inter-RAT CHO process, allowing the UE 200 to make more informed decisions and prepare for various handover scenarios proactively.

In some examples, executing the conditional handover may comprise sending an RRC reconfiguration complete message to the target cell. As illustrated in FIG. 6, this process may be observed in the interaction between the UE 200 and the 4G eNB 204. After the UE 200 has determined that the CHO criteria for 4G have been met, it may initiate the handover process by sending a Random Access Preamble 606 to the target 4G eNB 204. Upon receiving a Random Access Response 608 from the 4G eNB 204, the UE 200 may proceed to send the RRC Reconfiguration Complete message at step 610 to the target cell. This message may serve multiple purposes in the handover execution process. Firstly, it may confirm to the target cell that the UE 200 has successfully applied the new radio resource configuration and is ready to commence communication over the new RAT. The RRC Reconfiguration Complete message 610 may also include additional information to help facilitate a smooth transition, such as security parameters, capability information, and/or status reports on active data bearers. In some implementations, this message may trigger the target cell to finalize resource allocation for the UE 200 and/or to initiate the path switch process with the core network, as seen in steps 612 and 614 of FIG. 6. The contents of the RRC Reconfiguration Complete message may vary depending on the specific RAT involved in the handover. For instance, when transitioning to a 5G cell, the message may include information about the UE's 5G capabilities and/or preferred network slices. In a handover to a Wi-Fi network, the message may incorporate details relevant to Wi-Fi association and/or security protocols. The UE 200 may also use this message to provide feedback on the handover process, potentially including measurements taken during the transition and/or any issues encountered. This feedback may be useful for network optimization and/or future handover decisions. In some scenarios, the UE 200 may send multiple RRC Reconfiguration Complete messages, each tailored to different aspects of the handover process and/or addressing different network elements. The timing of this message may also be relevant, as it may be sent within a specific window to facilitate proper synchronization with the target cell. Additionally, the UE 200 may include in this message any requests for additional resources and/or configurations that may be needed to support its current applications and/or services in the new RAT environment.

In some examples, the conditional handover executed by the UE may conform to 3GPP Release 16 or a later specification. As illustrated in FIG. 6, the conditional handover process may involve several steps that align with the 3GPP Release 16 specifications and/or subsequent releases. The RRC Reconfiguration message containing CHO information at step 602 sent from the 5G gNB 202 to the UE 200 may follow the format and content requirements outlined in these specifications. Similarly, the Measurement Report at step 604 sent by the UE 200 may adhere to the reporting criteria and measurement objects defined in Release 16 or later. The Random Access Preamble at step 606 and Random Access Response at step 608 exchanged between the UE 200 and the 4G eNB 204 may also conform to the specified procedures for inter-RAT handovers. Furthermore, the RRC Reconfiguration Complete message at step 610 sent by the UE 200 to the target 4G eNB 204 may include all mandatory information elements as required by the applicable 3GPP release. The subsequent Path Switch Request at step 612 and Path Switch Request ACK at step 614 exchanged between the 4G eNB 204 and the Core Network 600 may also follow the protocols defined in Release 16 or later specifications, helping facilitate a standardized and interoperable handover process across different network implementations.

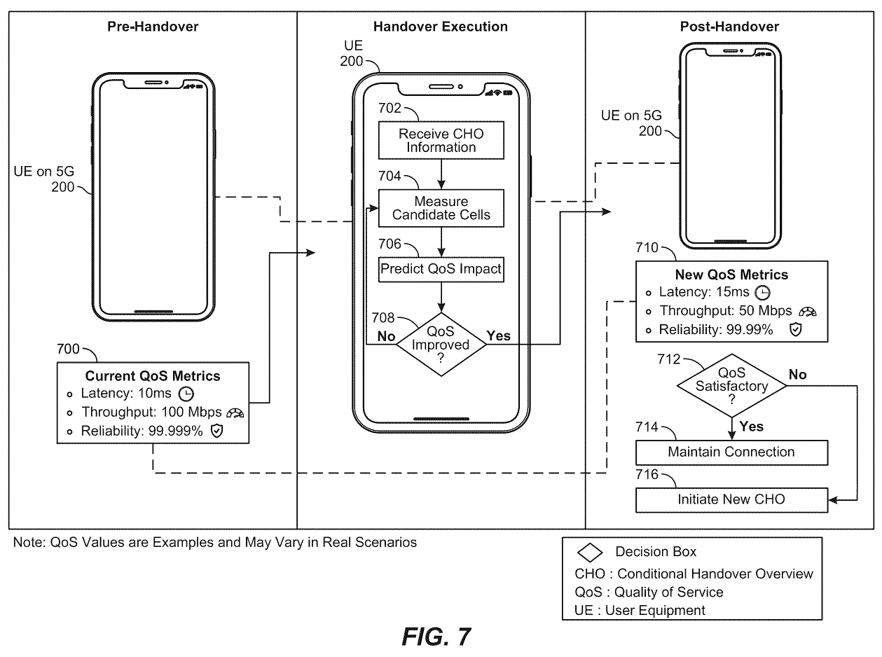

FIG. 7 shows a diagram illustrating an example Quality of Service (QoS) evaluation process during a multi-RAT conditional handover. The figure is divided into three vertical sections labeled “Pre-Handover”, “Handover Execution”, and “Post-Handover”, providing a visual representation of the QoS assessment at different stages of the handover process. In the Pre-Handover section, a smartphone icon represents UE 200 connected to a 5G network. Below this icon, step 700 shows a box containing Current QoS Metrics. These metrics may include latency, throughput, and/or reliability values, which may serve as a baseline for comparing the performance of potential handover targets. The specific values shown (10 ms latency, 100 Mbps throughput, 99.999% reliability) are examples and may vary in real-world scenarios depending on network conditions, user location, and/or other factors. These initial QoS metrics may be continuously monitored and/or updated by the UE, potentially using various measurement techniques and/or algorithms to provide accurate and/or up-to-date performance data.

The Handover Execution section depicts the decision-making process within UE 200. At step 702, the UE may receive CHO Information, which may include parameters and/or thresholds for evaluating potential handover targets across different RATs. This information may be provided by the network and may be tailored to current network conditions and/or operator policies. In step 704, the UE may measure candidate cells, which may involve scanning for signals from nearby base stations and/or access points across multiple RATs. These measurements may include signal strength indicators, quality metrics, and/or other relevant parameters that may help assess the potential performance of each candidate cell. Step 706 shows the UE predicting the QoS impact of a potential handover. This prediction process may involve complex algorithms that consider factors such as historical performance data, current network load, and/or the specific requests of active applications. The UE may use machine learning techniques to improve the accuracy of these predictions over time, potentially adapting to user behavior patterns and/or varying network conditions.

At step 708, the UE may determine if the predicted QoS would be improved by executing a handover. This decision may involve comparing the predicted QoS metrics against the current performance and/or any defined thresholds or preferences. If the predicted QoS is not improved, the process may loop back to step 704 to continue measuring candidate cells. This loop may represent the ongoing nature of the CHO process, where the UE continuously evaluates potential handover targets to identify opportunities for improved performance. If the predicted QoS is improved, the process may proceed to the Post-Handover section. In the Post-Handover section, the UE 200 is shown connected to a 4G network, representing a completed handover. Step 710 displays New QoS Metrics, which may be measured after the handover is executed. These metrics may be compared to the pre-handover values to assess the actual impact of the handover on performance. The example values shown (15 ms latency, 50 Mbps throughput, 99.99% reliability) may illustrate a trade-off between different QoS parameters that may occur when transitioning between RATs.

Step 712 represents a decision point where the UE determines if the new QoS is satisfactory. This evaluation may consider multiple factors, including the specific requirements of active applications, user preferences, and/or predefined performance thresholds. If the QoS is satisfactory, the process may proceed to step 714, where the UE maintains the new connection. This maintenance may involve ongoing monitoring and/or potential optimizations to help facilitate consistent performance. If the QoS is not satisfactory, the process may move to step 716, where a new CHO may be initiated. This step may involve restarting the handover process with updated criteria and/or considering alternative candidate cells. The inclusion of this step may highlight the adaptive nature of the CHO process, where the UE may continuously seek to improve its connection quality across multiple RATs. The dashed lines connecting similar elements across sections may help visualize the flow of the QoS evaluation process throughout the handover procedure. This continuous evaluation may help facilitate more informed handover decisions and/or may contribute to improved overall user experience in multi-RAT environments.

In some examples, selecting the target cell may comprise measuring a quality of service parameter for the target cell, comparing the measured quality of service parameter to a threshold value, and selecting the target cell based on the measured quality of service parameter exceeding the threshold value. This process may be implemented through various techniques that enhance the accuracy and efficiency of conditional handover decisions. The quality of service parameters may encompass a wide range of metrics, potentially including latency, throughput, packet loss rate, jitter, and/or application-specific performance indicators. In some implementations, the UE may measure multiple QoS parameters simultaneously, creating a multi-dimensional evaluation of potential target cells. As illustrated in FIG. 7, the UE may consider Current QoS Metrics 700 as a baseline for comparison with potential target cells. The measurement process may involve active probing techniques, where the UE may send test packets to potential target cells and analyze the responses. Alternatively, passive monitoring methods may be employed, where the UE may observe ongoing network traffic to infer QoS characteristics. The UE may also leverage historical data and machine learning algorithms to predict future QoS performance based on past trends and patterns, potentially improving the accuracy of the Predict QoS Impact 706 step. The threshold values used for comparison may be dynamic and context-aware, potentially adjusting based on factors such as time of day, network load, user mobility patterns, and/or specific application requirements. In some scenarios, the UE may use a weighted scoring system to evaluate multiple QoS parameters against their respective thresholds, allowing for a more nuanced selection process. The comparison itself may involve statistical analysis techniques, such as moving averages or exponential smoothing, to account for short-term fluctuations in QoS measurements. Additionally, the UE may implement hysteresis mechanisms to prevent frequent oscillations between cells due to minor QoS variations, which may be reflected in the QoS Improved? decision point of step 708. The selection criteria may also incorporate predictive elements, where the UE may anticipate future QoS based on trajectory and network topology information. This forward-looking technique may help facilitate more stable and long-lasting handover decisions. Moreover, the UE may consider the potential impact of the handover itself on QoS, factoring in any temporary service disruptions during the transition process. The ongoing evaluation of New QoS Metrics 710 after handover may provide feedback for refining future QoS predictions and threshold adjustments. By employing these diverse methods and considerations, the QoS-based target cell selection process may adapt to a wide range of network environments and user scenarios, potentially improving the overall efficiency and reliability of conditional handovers.

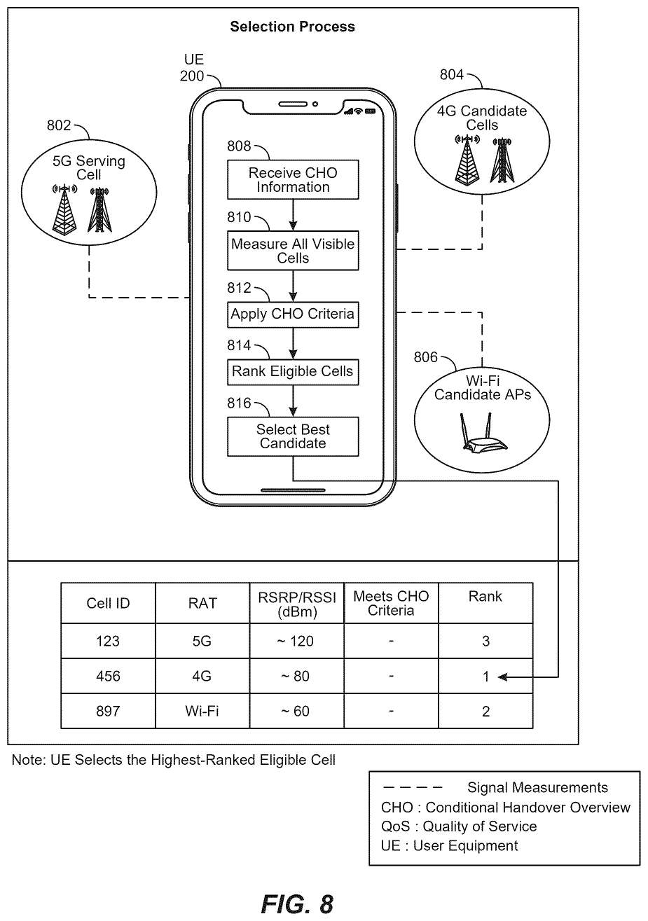

FIG. 8 shows a diagram illustrating an example candidate selection process for inter-RAT conditional handover. The figure is divided into two main sections: the top two-thirds depicting the selection process and the bottom third showing a table of candidate cells. In the top section, a large smartphone icon labeled UE 200 is prominently displayed in the center, representing the user equipment involved in the handover process. Surrounding the UE 200, circular sectors represent different Radio Access Technologies (RATs). These sectors are labeled as 5G Serving Cell 802, 4G Candidate Cells 804, and Wi-Fi Candidate APs 806, illustrating the multi-RAT environment in which the UE may operate. Within each sector, 2-3 small tower or antenna icons represent individual cells or access points, providing a visual representation of the network topology. Dotted lines extend from the UE 200 to each cell/AP, symbolizing the signal measurements that the UE may perform during the candidate cell selection process.

Inside the UE 200 icon, a flowchart illustrates the internal decision-making process for candidate cell selection. The flowchart begins with step 808, where the UE may receive CHO Information. This information may include parameters, thresholds, and/or criteria that the UE may use to evaluate potential handover targets across different RATs. The flowchart then progresses to step 810, where the UE may measure all visible cells. This step may involve scanning the radio environment and collecting signal strength and/or quality measurements from nearby cells across multiple RATs. The measurements may include metrics such as Reference Signal Received Power (RSRP) for cellular networks and/or Received Signal Strength Indicator (RSSI) for Wi-Fi networks. In step 812, the UE may apply CHO criteria to the measured cells. This step may involve comparing the collected measurements against the thresholds and/or conditions specified in the CHO information received earlier. The criteria may include factors such as minimum signal strength, quality thresholds, and/or RAT-specific parameters. The flowchart continues with step 814, where the UE may rank eligible cells. This ranking process may consider multiple factors beyond simple signal strength, potentially including predicted Quality of Service (QoS), energy efficiency, and/or user preferences. The ranking algorithm may assign weights to different parameters based on their relative importance in the current context. Finally, in step 816, the UE may select the best candidate for handover. This selection may typically be the highest-ranked cell, but the UE may also consider additional factors such as the potential for ping-pong effects or the historical stability of the candidate cell. The bottom section of the figure displays a Candidate Cell Table, which may provide a detailed view of the cells considered in the selection process. The table includes columns for Cell ID, RAT, RSRP/RSSI (dBm), whether the cell meets CHO criteria, and its rank. Sample data populates the table, showcasing 2-3 rows for each RAT (5G, 4G, Wi-Fi) with values for RSRP/RSSI. The ranks assigned to eligible cells demonstrate the outcome of the ranking process performed in step 814.

In some examples, the method may further comprise reporting, by the UE to the network, measurements of multiple neighbor cells supporting the second RAT. This reporting process may be implemented through various techniques to provide comprehensive and accurate information to the network for efficient handover decision-making. The UE may employ different measurement strategies depending on the network environment and available resources. For instance, the UE may perform periodic measurements at fixed intervals or adopt an event-triggered approach where measurements are reported only when specific conditions are met. As illustrated in FIG. 8, the UE 200 may measure all visible cells at step 810 across different RATs, including 4G Candidate Cells 804 and Wi-Fi Candidate APs 806. The measurement process may involve assessing various parameters such as signal strength, quality indicators, and/or channel conditions for each neighbor cell. In some implementations, the UE may prioritize measurements based on historical data, potentially focusing more resources on cells that have previously provided good connectivity. The UE may also employ advanced prediction algorithms to anticipate which cells are likely to become viable candidates in the near future, based on factors such as the UE's movement pattern and known network topology. The reporting mechanism may be optimized to balance the need for comprehensive information with minimizing signaling overhead. For example, the UE may implement compression techniques to reduce the size of measurement reports or use differential reporting to only transmit changes since the last report. The UE may also adapt its reporting frequency based on the stability of the network environment, potentially increasing the reporting rate in highly dynamic scenarios. In multi-RAT environments, the UE may normalize measurements across different technologies to provide a consistent basis for comparison. This may involve developing equivalence metrics or conversion factors to translate measurements between RATs. The UE may also include contextual information in its reports, such as the current application requirements or battery status, to help the network make more informed decisions. Additionally, the UE may implement collaborative measurement techniques, potentially sharing information with nearby devices to create a more comprehensive view of the network environment. This peer-to-peer measurement sharing may be particularly helpful in crowded areas or for detecting hidden nodes. The measurement and reporting process may also be integrated with machine learning algorithms that continuously refine the measurement strategy based on the outcomes of previous handovers, potentially improving the accuracy and relevance of reported data over time.

In some examples, selecting the target cell may comprise choosing a cell with a best received signal strength indicator (RSSI) or best reference signal received power (RSRP) among multiple candidate cells. This selection process may involve a variety of techniques and considerations to determine the most suitable target cell for handover. As illustrated in FIG. 8, the UE 200 may evaluate multiple candidate cells, including 4G Candidate Cells 804 and/or Wi-Fi Candidate APs 806, to identify the cell with the strongest signal. The measurement of RSSI and/or RSRP may be performed as part of the Measure All Visible Cells 810 step. However, the selection process may go beyond simple signal strength comparisons. The UE may implement weighted algorithms that consider both RSSI and/or RSRP along with other factors such as cell load, historical performance data, and/or predicted future signal strength based on the UE's movement pattern. In some scenarios, the UE may utilize a sliding window technique to average RSSI and/or RSRP measurements over time, potentially mitigating the impact of short-term signal fluctuations. The selection process may also incorporate hysteresis mechanisms to prevent ping-pong effects between cells with similar signal strengths. Additionally, the UE may employ machine learning algorithms to predict the future RSSI and/or RSRP of candidate cells based on historical data and/or environmental factors. This predictive technique may be particularly helpful in dynamic environments where signal strengths may change rapidly. The UE may also consider the rate of change of RSSI and/or RSRP, potentially favoring cells with stable or improving signal strengths over those with declining trends. Furthermore, the UE may implement a multi-stage selection process where initial candidates are chosen based on RSSI and/or RSRP, followed by more detailed evaluations of other parameters. This technique may help balance the need for quick initial selections with more comprehensive final decisions. The UE may also adapt its selection criteria based on the current application requirements, potentially prioritizing different aspects of signal strength depending on whether the user is engaged in voice calls, video streaming, or/or data-intensive tasks.

In some examples, the method may further comprise sorting multiple candidate cells based on signal strength measurements before selecting the target cell. This sorting process may involve a variety of techniques and considerations to effectively rank potential handover targets. As illustrated in FIG. 8, the UE 200 may evaluate multiple candidate cells, including 4G Candidate Cells 804 and/or Wi-Fi Candidate APs 806, during the Measure All Visible Cells 810 step. The sorting technique may extend beyond simple signal strength comparisons and may incorporate multiple factors to create a comprehensive ranking system. For instance, the UE may employ weighted algorithms that consider not only raw signal strength measurements but also factors such as signal quality, historical cell performance, and/or predicted future signal trends. The sorting process may utilize advanced statistical methods, such as moving averages or/and exponential smoothing, to account for temporal variations in signal strength and/or provide a more stable ranking over time. In some implementations, the UE may apply machine learning algorithms to dynamically adjust the sorting criteria based on past handover successes and/or failures, potentially improving the accuracy of cell rankings over time. The sorting technique may also consider the rate of change of signal strengths, potentially giving higher rankings to cells with stable or/and improving signals compared to those with volatile or/and declining trends. In multi-RAT scenarios, the sorting process may need to normalize measurements across different technologies, which may involve complex calculations to create comparable metrics between diverse network types. The UE may implement a multi-tiered sorting approach, where cells are first grouped into broad categories based on signal strength ranges, and/and then fine-grained sorting is applied within each category. This technique may help balance computational efficiency with ranking accuracy. Additionally, the sorting process may incorporate contextual information such as the UE's movement speed and/or direction, potentially adjusting rankings based on predicted future positions. The sorted list may be continuously updated as part of an iterative process, with new measurements triggering re-evaluations of the cell rankings. This dynamic sorting technique may be helpful in rapidly changing network environments.

In some examples, the method may further comprise reattempting the conditional handover with a next best candidate cell based on one or more candidate cells in an initial list failing to meet handover criteria. This reattempt process may involve a variety of techniques to efficiently identify and connect to alternative target cells when initial handover attempts are unsuccessful. As illustrated in FIG. 8, the UE 200 may maintain a list of candidate cells, including 4G Candidate Cells 804 and/or Wi-Fi Candidate APs 806, which may be continuously updated and/or ranked. The reattempt technique may leverage this ranked list to swiftly select the next best candidate when a handover fails. The process may involve dynamic re-evaluation of the candidate list, potentially incorporating real-time updates to signal measurements, network conditions, and/or other relevant parameters. In some implementations, the UE may employ adaptive algorithms that adjust the selection criteria for subsequent attempts based on the nature of previous failures. For instance, if a handover fails due to poor signal quality, the algorithm may place greater emphasis on signal strength metrics in selecting the next candidate. The reattempt process may also incorporate a backoff mechanism, where the UE may introduce short delays between attempts to avoid network congestion and/or allow for potential improvements in cell conditions. Additionally, the UE may implement parallel preparation techniques, where it may initiate preliminary handover procedures with multiple candidates simultaneously, allowing for faster transitions to alternative cells if the primary target fails. The reattempt strategy may also consider the rate of change in network conditions, potentially prioritizing more stable cells for subsequent attempts in highly dynamic environments. In multi-RAT scenarios, the reattempt process may intelligently switch between different RATs, potentially exploring alternatives across various technologies to find the most suitable connection. The UE may also employ predictive modeling to anticipate the likelihood of successful handover for each remaining candidate, potentially optimizing the order of reattempts. Furthermore, the reattempt process may incorporate user experience factors, such as application requirements and/or battery life considerations, in selecting subsequent candidates. This technique may help balance network performance with device-specific needs during the handover process.

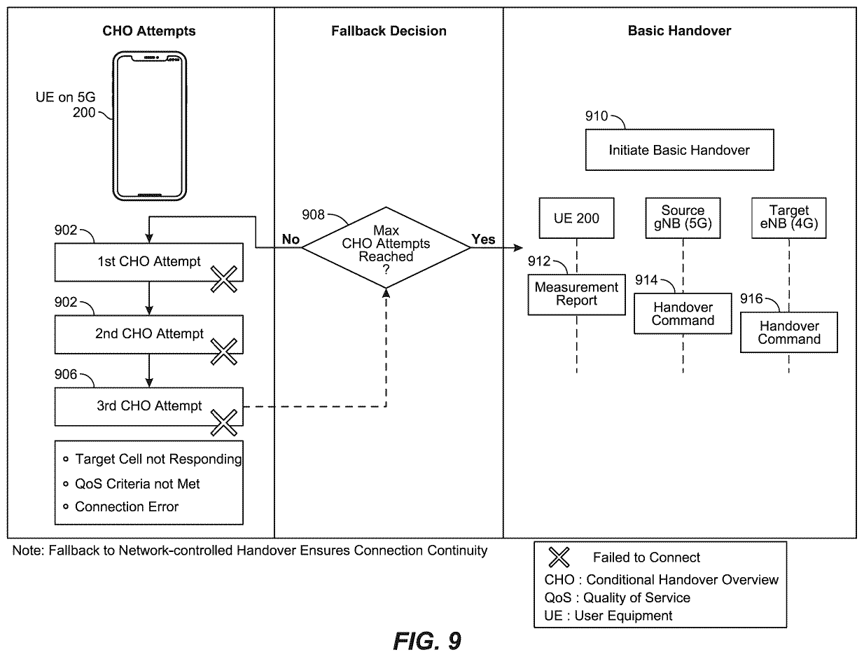

FIG. 9 shows a diagram illustrating an example fallback mechanism for inter-RAT conditional handover when CHO attempts fail. The figure is divided into three vertical sections: “CHO Attempts”, “Fallback Decision”, and “Basic Handover”, providing a visual representation of the progression from autonomous handover attempts to a network-controlled fallback procedure. In the CHO Attempts section, a smartphone icon labeled UE 200 on 5G is shown at the top, representing the initial state of the user equipment. Below this icon, three numbered boxes represent successive CHO attempts: step 902 (1st CHO Attempt), step 904 (2 nd CHO Attempt), and step 906 (3rd CHO Attempt). Arrows between these boxes indicate the progression of attempts, while small “X” icons next to each box symbolize the failure of each attempt. This visual sequence may illustrate the persistent nature of the CHO process, where the UE may continue to attempt handovers even in challenging network conditions. Adjacent to the CHO attempt boxes, a small annotation box explains potential failure reasons, such as the target cell not responding, QoS criteria not being met, and/or connection errors. These annotations may provide context for the various factors that may contribute to CHO failures in real-world scenarios.

The Fallback Decision section is centered around a large decision diamond labeled step 908, posing the question “Max CHO Attempts Reached?” This decision point may represent a key aspect of the fallback mechanism, determining whether to continue with CHO attempts or transition to a basic handover procedure. Two arrows emerge from this diamond: a left arrow labeled “No” that loops back to the CHO Attempts section, and a right arrow labeled “Yes” that leads to the Basic Handover section. The looping “No” arrow may illustrate the system's ability to persist with CHO attempts if the maximum number has not been reached, potentially enabling for additional opportunities to complete an autonomous handover. A dashed arrow from the last CHO attempt to the Fallback Decision diamond may visually connect the CHO process to the decision point, emphasizing the sequential nature of the fallback mechanism.

The Basic Handover section begins with step 910, labeled “Initiate Basic Handover”. Below this, a simplified sequence diagram shows the interactions between UE 200, Source gNB (5G), and Target eNB (4G) during a basic handover process. The diagram includes step 912 (Measurement Report), step 914 (Handover Command), and step 916 (Handover Complete), representing example stages of a network-controlled handover. This section may illustrate how the system may revert to a more conventional handover procedure when autonomous attempts are unsuccessful, potentially helping facilitate continued connectivity in challenging scenarios.

In some examples, the method may further comprise reattempting the conditional handover to a second candidate cell based on the conditional handover to the selected target cell failing. This reattempt process may involve a variety of techniques to efficiently identify and connect to alternative target cells when initial handover attempts are unsuccessful. As illustrated in FIG. 9, the UE 200 may undergo multiple CHO attempts, represented by steps 902, 904, and 906, before potentially falling back to a basic handover procedure. The reattempt technique may leverage a dynamically maintained and/or ranked list of candidate cells to swiftly select the next best candidate when a handover fails. This process may involve real-time updates to signal measurements, network conditions, and/or other relevant parameters. The UE may employ adaptive algorithms that adjust the selection criteria for subsequent attempts based on the nature of previous failures. For instance, if a handover fails due to poor signal quality, the algorithm may place greater emphasis on signal strength metrics in selecting the next candidate. The reattempt process may also incorporate a backoff mechanism, where the UE may introduce short delays between attempts to avoid network congestion and/or allow for potential improvements in cell conditions. This backoff technique may be reflected in the progression from step 902 to 904 to 906 in FIG. 9. Additionally, the UE may implement parallel preparation techniques, where it may initiate preliminary handover procedures with multiple candidates simultaneously, allowing for faster transitions to alternative cells if the primary target fails. The reattempt strategy may also consider the rate of change in network conditions, potentially prioritizing more stable cells for subsequent attempts in highly dynamic environments. In multi-RAT scenarios, the reattempt process may intelligently switch between different RATs, potentially exploring alternatives across various technologies to find the most suitable connection. This may be particularly relevant when transitioning between the CHO attempts and the basic handover procedure shown in step 910. The UE may also employ predictive modeling to anticipate the likelihood of successful handover for each remaining candidate, potentially optimizing the order of reattempts. Furthermore, the reattempt process may incorporate user experience factors, such as application requirements and/or battery life considerations, in selecting subsequent candidates. This technique may help balance network performance with device-specific needs during the handover process. The decision to continue reattempting or fall back to a basic handover, as represented by step 908, may be influenced by a combination of these factors and/or network-defined parameters.

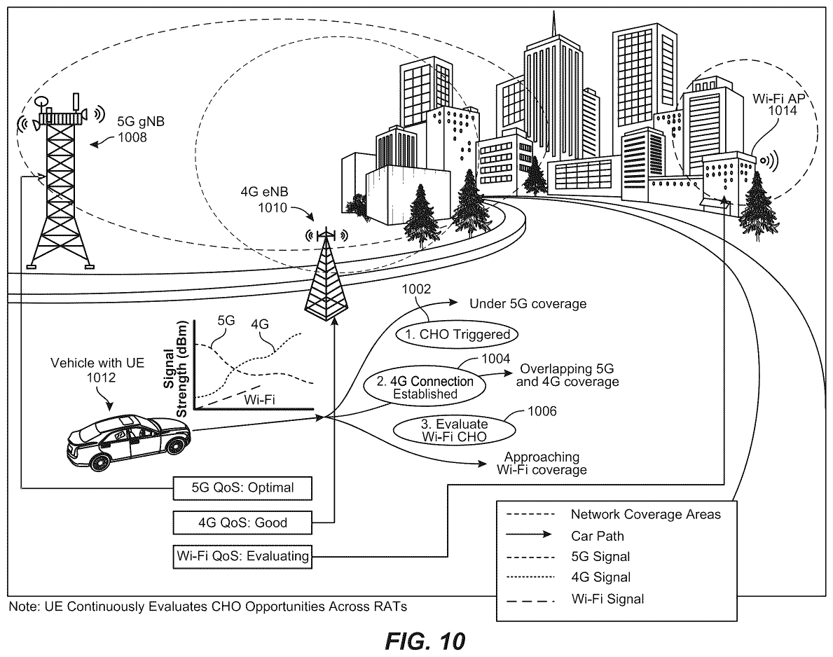

FIG. 10 shows an example diagram illustrating a real-world scenario of inter-RAT conditional handover in a dynamic urban environment. The figure depicts a simplified urban skyline across the top, with various building shapes representing a city environment, interspersed with trees and a road running through the scene. This background provides context for the network infrastructure and user equipment interactions that may occur in a typical metropolitan setting. The network infrastructure is represented by three key elements: a tall 5G tower labeled 5G gNB 1008 on the left side, a smaller 4G tower labeled 4G eNB 1010 in the center, and a building with a Wi-Fi symbol labeled Wi-Fi AP 1014 on the right side. Each of these network elements has circular sectors drawn with dashed lines to represent their respective coverage areas, illustrating the overlapping and dynamic nature of wireless network coverage in urban environments. A car labeled “Vehicle with UE 1012” is shown in the bottom left corner representing the user equipment in motion. An arrow indicates the car's movement path from left to right across the scene. This movement is divided into three segments, each representing a different phase of the inter-RAT conditional handover process. Segment 1 shows the vehicle under 5G coverage, Segment 2 depicts an area of overlapping 5G and 4G coverage, and Segment 3 represents the approach to Wi-Fi coverage.

At each segment transition, numbered circles indicate key events in the CHO process: step 1002 (CHO Triggered) between segments 1 and 2, step 1004 (4G Connection Established) in the middle of segment 2, and step 1006 (Evaluate Wi-Fi CHO) between segments 2 and 3. These markers may help visualize the decision points and actions taken by the UE as it moves through different network environments. Above the car's path, a simple graph shows the signal strength of the different networks. The y-axis is labeled “Signal Strength (dBm)”, and different line styles are used to represent 5G, 4G, and Wi-Fi signals. The graph shows the 5G signal decreasing as the vehicle moves away from the 5G tower, the 4G signal increasing and then stabilizing as the vehicle enters its coverage area, and the Wi-Fi signal emerging as the vehicle approaches the Wi-Fi access point. This visual representation may help illustrate the changing network conditions that the UE may evaluate for potential handovers. Below the car's path, three boxes represent the QoS states associated with each network: 5G QoS: Optimal, 4G QoS: Good, and Wi-Fi QoS: Evaluating. These boxes are connected to relevant points along the car's path, potentially indicating how the UE may assess the quality of service offered by each network as it moves through the urban environment.

In some examples, the user equipment (UE) may implement parallel processing techniques for inter-RAT conditional handover (CHO) attempts, potentially improving the efficiency and success rate of handovers in dynamic network environments. This parallel approach may involve the UE simultaneously initiating multiple CHO offers or handshakes with different target cells across various RATs. For instance, as depicted in FIG. 10, the UE 1012 moving through an urban environment may concurrently evaluate and initiate CHO processes with both the 4G eNB 1010 and the Wi-Fi AP 1014 while still connected to the 5G gNB 1008. The UE may send out multiple CHO requests or preparation messages to these different target cells, each containing the information used for potential handover execution. These parallel attempts may be prioritized based on various factors such as signal strength, predicted quality of service, and/or historical performance data. The UE may maintain separate state machines or timers for each ongoing CHO attempt, allowing for independent progression and evaluation of each potential handover target. As the CHO processes evolve, the UE may continuously update its ranking of the candidate cells based on the latest measurements and responses received. In the event that multiple CHO attempts progress successfully, the UE may select the first to respond and/or most favorable option based on predefined criteria or real-time network conditions. This selection may involve comparing the latest QoS predictions, as illustrated by the QoS state boxes 1008, 1010, and 1012 in FIG. 10, and choosing the RAT that offers the best balance of performance metrics for the current user context. Once a preferred CHO target is selected, the UE may proceed with finalizing the handover to that cell while simultaneously canceling or releasing resources associated with the other ongoing CHO attempts. This cancellation process may involve sending explicit abort messages to the non-selected target cells or simply allowing the CHO preparation states to time out. The parallel CHO technique may also incorporate adaptive algorithms that adjust the number of simultaneous attempts based on factors such as available processing power, battery life, and/or network responsiveness. In scenarios where network conditions are highly volatile, the UE may increase the number of parallel CHO attempts to improve the chances of successful handover, while in more stable environments, it may limit parallel attempts to conserve resources. Additionally, the UE may employ predictive modeling to anticipate which RATs are likely to provide optimal performance in the near future, as shown by the signal strength graph in FIG. 10, and prioritize CHO attempts accordingly. This parallel processing approach may help reduce overall handover latency by eliminating the need for sequential attempts and may provide a more robust handover mechanism in complex multi-RAT environments.

In some examples, the inter-RAT conditional handover (CHO) technique may be extended to encompass a wide variety of radio access technologies (RATs) beyond the 4G, 5G, and/or Wi-Fi networks. The UE may be configured to evaluate and/or initiate handovers across a diverse spectrum of wireless communication technologies, including but not limited to legacy cellular networks such as 2G (GSM) and/or 3G (UMTS), as well as emerging and/or future network technologies. For instance, the CHO process may incorporate evaluation of 6G networks as they become available, potentially leveraging advanced features such as terahertz frequency bands, massive MIMO configurations, and/or intelligent reflecting surfaces. The UE may also consider non-cellular wireless technologies for handover, such as near-field communication (NFC) for ultra-short-range high-bandwidth transfers, or satellite-based communications for areas with limited terrestrial coverage. In urban environments, the UE may additionally evaluate handover opportunities to specialized RATs designed for smart city applications, such as low-power wide-area networks (LPWAN) or dedicated short-range communications (DSRC) used in intelligent transportation systems. The CHO technique may also be adapted to consider optical wireless communication (OWC) technologies, including visible light communication (VLC) or Li-Fi, which may be particularly useful in indoor environments or in scenarios where radio frequency emissions are restricted. As new RATs emerge, the CHO process may be updated to include evaluation criteria specific to these technologies, such as molecular communication for nanonetworks or quantum communication systems for ultra-secure data transmission. The UE may also consider hybrid RATs that combine multiple technologies, such as integrated satellite-terrestrial networks or heterogeneous networks that seamlessly blend cellular and non-cellular technologies. Furthermore, the CHO technique may be extended to incorporate evaluation of future iterations of existing RATs, such as Wi-Fi 7 (802.11be) or beyond, which may offer enhanced features like multi-link operation or extreme high throughput. The UE may also consider handovers to specialized industrial wireless networks, such as those based on the ISA100.11a or WirelessHART standards, in scenarios where robust and deterministic communication is required. By considering this broad spectrum of RATs, the CHO technique may provide a flexible and future-proof mechanism for maintaining optimal connectivity across diverse and evolving wireless ecosystems.

In some examples, the inter-RAT conditional handover technique may be implemented through various network-side modifications and enhancements, potentially complementing or/and supplementing the UE-centric techniques previously discussed. Network elements, such as base stations, access points, and/or core network components, may be configured to facilitate and/or optimize the conditional handover process. For instance, the network may implement advanced prediction algorithms to anticipate potential handover scenarios based on historical data, network topology, and/or user movement patterns. This predictive capability may allow the network to proactively prepare resources and/or initiate handover procedures before receiving explicit requests from UEs. The network may also employ dynamic resource allocation techniques, potentially reserving bandwidth and/or computing resources for imminent handovers based on real-time analysis of network conditions and/or UE measurements. In some implementations, the network may utilize machine learning algorithms to continuously refine its handover policies, potentially adapting to changing traffic patterns, device capabilities, and/or service requirements. The network may also implement collaborative decision-making processes, where multiple network elements share information and/or jointly determine the best handover targets for UEs. This collaborative technique may be particularly helpful in heterogeneous network environments with overlapping coverage from different RATs. Additionally, the network may employ advanced load balancing algorithms that consider not only signal strength but also cell capacity, quality of service requirements, and/or overall network efficiency when selecting handover targets. The network may also implement sophisticated signaling protocols that reduce the overhead associated with handover preparation and/or execution, potentially improving the speed and/or reliability of inter-RAT transitions. In some scenarios, the network may take a more active role in handover decisions, potentially overriding UE preferences based on broader network optimization goals. The network may also implement adaptive measurement reporting schemes, dynamically adjusting the frequency and/or content of measurement reports requested from UEs based on current network conditions and/or handover likelihood. Furthermore, the network may employ advanced interference management techniques to create more favorable conditions for successful handovers, potentially coordinating transmissions across multiple cells and/or RATs to minimize disruptions during the transition process.

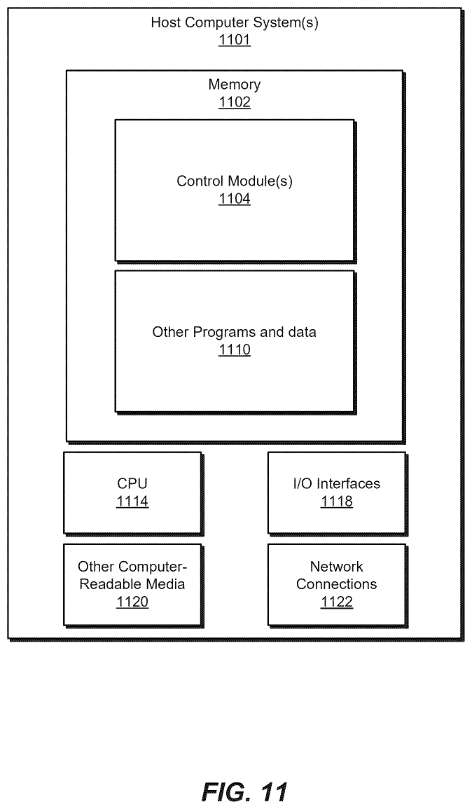

FIG. 11 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a user equipment (UE) operating on a first radio access technology (RAT), a radio resource control (RRC) reconfiguration message from a network that includes conditional handover (CHO) information that is specific to a second RAT different from the first RAT;
selecting, by the UE, a target cell supporting the second RAT when signal measurements of the target cell satisfy criteria specified in the CHO information; and
executing, by the UE, a conditional handover to the selected target cell such that the UE autonomously transitions from the first RAT to the second RAT.

2. The method of claim 1, wherein the first RAT comprises a 5G network and the second RAT comprises a 4G network or a Wi-Fi network.

3. The method of claim 1, wherein the CHO information specifies a conditional preparation phase that prepares multiple candidate cells for potential handover or a conditional execution phase that triggers the UE to execute the handover to the selected target cell.

4. The method of claim 1, wherein selecting the target cell comprises:
measuring a quality of service parameter for the target cell;
comparing the measured quality of service parameter to a threshold value; and
selecting the target cell based on the measured quality of service parameter exceeding the threshold value.

5. The method of claim 1, wherein the RRC reconfiguration message comprises an event type specifying a conditional event for inter-RAT handover.

6. The method of claim 1, further comprising reporting, by the UE to the network, measurements of multiple neighbor cells supporting the second RAT.

7. The method of claim 6, wherein the network sends RRC reconfiguration messages for multiple candidate cells based on the reported measurements.

8. The method of claim 1, wherein selecting the target cell comprises choosing a cell with a best received signal strength indicator (RSSI) or best reference signal received power (RSRP) among multiple candidate cells.

9. The method of claim 1, further comprising reattempting the conditional handover to a second candidate cell based on the conditional handover to the selected target cell failing.

10. The method of claim 1, wherein the CHO information comprises at least one threshold value for triggering the conditional handover.

11. The method of claim 10, wherein the at least one threshold value comprises a first threshold for a B1 event that triggers based on a neighbor cell becoming better than the first threshold, or a second threshold and a third threshold for a B2 event that triggers based on a serving cell becoming worse than the second threshold and a neighbor cell becoming better than the third threshold, wherein the second threshold and the third threshold are the same or different.

12. The method of claim 1, further comprising sorting multiple candidate cells based on signal strength measurements before selecting the target cell.

13. The method of claim 1, wherein executing the conditional handover comprises sending an RRC reconfiguration complete message to the target cell.

14. The method of claim 1, further comprising the UE falling back to a basic handover procedure based on the conditional handover failing after a predetermined number of attempts.

15. The method of claim 1, wherein the conditional handover executed by the UE conforms to 3GPP Release 16 or a later specification.

16. The method of claim 1, further comprising reattempting the conditional handover with a next best candidate cell based on one or more candidate cells in an initial list failing to meet handover criteria.

17. A non-transitory computer-readable medium that has instructions stored thereon that, when executed by at least one physical computing processor, cause a computing device to perform operations comprising:
receiving, by a user equipment (UE) operating on a first radio access technology (RAT), a radio resource control (RRC) reconfiguration message from a network that includes conditional handover (CHO) information that is specific to a second RAT different from the first RAT;
selecting, by the UE, a target cell supporting the second RAT when signal measurements of the target cell satisfy criteria specified in the CHO information; and
executing, by the UE, a conditional handover to the selected target cell such that the UE autonomously transitions from the first RAT to the second RAT.

18. The non-transitory computer-readable medium of claim 17, wherein the conditional handover executed by the UE conforms to 3GPP Release 16 or a later specification.

19. A system comprising:
at least one physical computing processor of a computing device; and
a non-transitory computer-readable medium that has instructions stored thereon that, when executed by the at least one physical computing processor, cause the computing device to perform operations comprising:
receiving, by a user equipment (UE) operating on a first radio access technology (RAT), a radio resource control (RRC) reconfiguration message from a network that includes conditional handover (CHO) information that is specific to a second RAT different from the first RAT;
selecting, by the UE, a target cell supporting the second RAT when signal measurements of the target cell satisfy criteria specified in the CHO information; and
executing, by the UE, a conditional handover to the selected target cell such that the UE autonomously transitions from the first RAT to the second RAT.

20. The system of claim 19, wherein the conditional handover executed by the UE conforms to 3GPP Release 16 or a later specification.
